(19) United States
(12) Patent Application Publication
(10) Pub. No.: US 2023/0278038 A1
(43) Pub. Date: Sep. 7, 2023

(54) FLOW FOCUSING DEVICES, SYSTEMS, AND METHODS FOR HIGH THROUGHPUT DROPLET FORMATION

(71) Applicant: 10x Genomics, Inc., Pleasanton, CA (US)

(72) Inventors: Mohammad RAHIMI LENJI, Livermore, CA (US); Yiran ZHANG, Castro Valley, CA (US); Francis MARCOGLIESE, Livermore, CA (US); Tobias Daniel WHEELER, Pleasanton, CA (US); Rajiv BHARADWAJ, Pleasanton, CA (US)

(21) Appl. No.: 18/177,562

(22) Filed: Mar. 2, 2023

Related U.S. Application Data
(63) Continuation of application No. PCT/US2021/048899, filed on Sep. 2, 2021.
(60) Provisional application No. 63/073,691, filed on Sep. 2, 2020.

(51) Int. Cl. B01L 3/00; B01F 23/41; B01F 33/3011

(52) U.S. Cl. CPC B01L 3/502792; B01F 23/4144; B01F 33/3011; B01F 23/4105; B01L 2300/0867; B01L 2200/16; B01L 2200/0673; B01L 2300/0816

(57) ABSTRACT

Devices, systems, and their methods of use, for generating and collecting droplets are provided. Devices use flow focusing arrangements of channels to produce droplets. The invention further provides multiplex devices that increase droplet formation.

### FIELD OF THE INVENTION

The invention provides devices, systems, and methods for droplet formation. For example, devices, systems, and methods of the invention may be used for forming droplets (e.g., emulsions) containing particles (e.g., droplets containing single particles) or for mixing liquids, e.g., prior to droplet formation.

### BACKGROUND OF THE INVENTION

Many biomedical applications rely on high-throughput assays of samples combined with one or more reagents in droplets. For example, in both research and clinical applications, high-throughput genetic tests using target-specific reagents are able to provide information about samples in drug discovery, biomarker discovery, and clinical diagnostics, among others.

Improved devices, systems, and methods for producing and collecting droplets would be beneficial.

### SUMMARY OF THE INVENTION

One aspect of the invention provides a device for producing droplets, the device including a flow path including a) one or more sample inlets; b) one or more reagent inlets; c) one or more oil inlets; d) one or more collection reservoirs; e) a first and a second sample channel, each in fluid communication with the one or more sample inlets; f) a first and a second reagent channel, each in fluid communication with the one or more reagent inlets; g) a first, second, third, and fourth oil channel in fluid communication with the one or more oil inlets; h) a first intersection at which the first reagent channel and the first sample channel intersect; i) a second intersection at which the second reagent channel and the second sample channel intersect; j) a first and a second droplet channel, where the first droplet channel is in fluid communication with the first intersection and the one or more collection reservoirs and the second droplet channel is in fluid communication with the second intersection and the one or more collection reservoirs; k) a third intersection at which the first and second oil channels and the first droplet channel intersect, where the third intersection is fluidically disposed between the first intersection and the one or more collection reservoirs; and l) a fourth intersection at which the third and fourth oil channels and the second droplet channel intersect, where the fourth intersection is fluidically disposed between the second intersection and the one or more collection reservoirs.

In some embodiments, the one or more sample inlets include a first and a second sample inlet, the one or more reagent inlets include a first reagent inlet, the one or more oil inlets include a first oil inlet, and the one or more collection reservoirs include a first and a second collection reservoir. The first sample channel is in fluid communication with the first sample inlet, the second sample channel is in fluid communication with the second sample inlet, the first droplet channel is in fluid communication with the first collection reservoir, the second droplet channel is in fluid communication with the second collection reservoir.

In some embodiments, the one or more sample inlets include a first sample inlet, the one or more reagent inlets include a first reagent inlet, the one or more oil inlets include a first and a second oil inlet, and the one or more collection reservoirs include a first collection reservoir. The first and third oil channels are in fluid communication with the first oil inlet and the second and fourth oil channels are in fluid communication with the second oil inlet.

In certain embodiments, the device further includes a third and a fourth sample channel each in fluid communication with the one or more sample inlets, where the third sample channel intersects the first reagent channel at the first intersection and the fourth sample channel intersects the second reagent channel at the second intersection. In particular embodiments, the one or more sample inlets include a first and a second sample inlet, the one or more reagent inlets include a first and a second reagent inlet, the one or more oil inlets include a first oil inlet, and the one or more collection reservoirs include a first and a second collection reservoir. The first and third sample channels are in fluid communication with the first sample inlet, the second and fourth sample channels are in fluid communication with the second sample inlet, the first reagent channel is in fluid communication with the first reagent inlet, the second reagent channel is in fluid communication with the second reagent inlet, the first droplet channel is in fluid communication with the first collection reservoir, and the second droplet channel is in fluid communication with the second collection reservoir. In other embodiments, the one or more sample inlets includes a first and a second sample inlet, the one or more reagent inlets include a first and a second reagent inlet, the one or more oil inlets include a first oil inlet, and the one or more collection reservoirs include a first collection reservoir. The first and third sample channels are in fluid communication with the first sample inlet, the second and fourth sample channels are in fluid communication with the second sample inlet, the first reagent channel is in fluid communication with the first reagent inlet, and the second reagent channel is in fluid communication with the second reagent inlet.

In some embodiments, the one or more reagent inlets includes a first and a second reagent inlet, the one or more sample inlets include a first and a second sample inlet, the first reagent channel is in fluid communication with the first reagent inlet, the first sample channel is in fluid communication with the first sample inlet, the second reagent channel is in fluid communication with the second reagent inlet, the second sample channel is in fluid communication with the second sample inlet, and one or more of the first through fourth oil channels is disposed between the first and second reagent inlets and/or between the first and second sample inlets. In some embodiments, the one or more collection reservoirs include first and second collection reservoirs. The first droplet channel is in fluid communication with the first collection reservoir, and the second droplet channel is in fluid communication with the second collection reservoir. In another embodiment, a third sample channel is in fluid communication with the first sample inlet, and a fourth sample channel is in fluid communication with the second sample inlet. The third sample channel intersects the first reagent channel at the first intersection, the fourth sample channel intersects the second reagent channel at the second intersection; and the third and fourth sample channels are disposed between the first and second reagent inlets. In some embodiment, the device further includes an oil waste reservoir and one or more oil waste channels, where each oil waste channel is in fluid communication with the oil waste reservoir and in fluid communication with the one or more collection reservoirs.

In some embodiments, the one or more collection reservoirs includes first and second collection reservoirs, the first droplet channel is in fluid communication with the first collection reservoir and the second droplet channel is in fluid communication with the second collection reservoir, and one or more of the first through fourth oil channels are disposed between the first and second collection reservoirs.

In some embodiments, at least one of the one or more sample channels and/or the one or more reagent channels include one or more rectifiers. In certain embodiments, at least one of the one or more sample channels and/or the one or more reagent channels includes a funnel.

Another aspect of the invention provides a method of producing droplets. The method includes (a) providing a device including a flow path including; i) one or more sample inlets; ii) one or more reagent inlets; iii) one or more oil inlets; iv) one or more collection reservoirs; v) a first and a second sample channel, each in fluid communication with the one or more sample inlets; vi) a first and a second reagent channel, each in fluid communication with the one or more reagent inlets; vii) a first, second, third, and fourth oil channel in fluid communication with the one or more oil inlets; viii) a first intersection at which the first reagent channel and the first sample channel intersect; ix) a second intersection at which the second reagent channel and the second sample channel intersect; x) a first and a second droplet channel, where the first droplet channel is in fluid communication with the first intersection and the one or more collection reservoirs and the second droplet channel is in fluid communication with the second intersection and the one or more collection reservoirs; xi) a third intersection at which the first and second oil channels and the first droplet channel intersect, where the third intersection is fluidically disposed between the first intersection and the one or more collection reservoirs; and xii) a fourth intersection at which the third and fourth oil channels and the second droplet channel intersect, where the fourth intersection is fluidically disposed between the second intersection and the one or more collection reservoirs. The method further includes (b) flowing one or more first fluids from the one or more sample inlets through the first and second sample channels, one or more second fluids from the one or more reagent inlets through the first and second reagent channels, and one or more third fluids through the first, second, third, and fourth oil channels; where one of the one or more first fluids and one of the one or more second fluids combine independently at the first and second intersections and produce droplets in the third fluid at the third and fourth intersections; and (c) collecting the droplets in the one or more collection reservoirs.

In some embodiments of the method, the one or more sample inlets of the device include a first and a second sample inlet, the one or more reagent inlets of the device include a first reagent inlet, the one or more oil inlets of the device include a first oil inlet, the one or more collection reservoirs of the device include a first and a second collection reservoir. The first sample channel is in fluid communication with the first sample inlet, the second sample channel is in fluid communication with the second sample inlet, the first droplet channel is in fluid communication with the first collection reservoir, and the second droplet channel is in fluid communication with the second collection reservoir. In such embodiments, step (b) includes flowing the one or more first fluids from the first and second sample inlets through the first and second sample channels and one second fluid from the first reagent inlet through the first and second reagent channels, and one third fluid from the first oil inlet through the first, second, third, and fourth oil channels; and step (c) includes collecting the droplets in the first and second collection reservoirs.

In some embodiments of the method, the one or more sample inlets of the device include a first sample inlet, the one or more reagent inlets of the device include a first reagent inlet, the one or more oil inlets of the device include a first and a second oil inlet, and the one or more collection reservoirs of the device include a first collection reservoir. The first and third oil channels are in fluid communication with the first oil inlet and the second and fourth oil channels are in fluid communication with the second oil inlet. Step (b) further includes flowing one first fluid from the first sample inlet through the first and second sample channels, one second fluid from the first reagent inlet through the first and second reagent channels, and one or more third fluids from the first and second oil inlets through the first, second, third, and fourth oil channels.

In some embodiments of the method, the device further includes a third and a fourth sample channel each in fluid communication with the one or more sample inlets, where the third sample channel intersects the first reagent channel at the first intersection, and the fourth sample channel intersects the second reagent channel at the second intersection. Step (b) then also includes flowing the one or more first fluids from the one or more sample inlets through the third and fourth sample channels and the one or more second fluids from the one or more reagent inlets through the third and fourth reagent channels. In particular embodiments, the one or more sample inlets of the device include a first and a second sample inlet, the one or more reagent inlets of the device include a first and a second reagent inlet, the one or more oil inlets of the device include a first oil inlet, and the one or more collection reservoirs of the device include a first and a second collection reservoir. The first and third sample channels are in fluid communication with the first sample inlet, the second and fourth sample channels are in fluid communication with the second sample inlet, the first reagent channel is in fluid communication with the first reagent inlet, the second reagent channel is in fluid communication with the second reagent inlet, the first droplet channel is in fluid communication with the first collection reservoir, and the second droplet channel is in fluid communication with the second collection reservoir. Step (b) then further includes flowing the one or more first fluids from the first and second sample inlets through the first, second, third, and fourth sample channels, the one or more second fluids from the first and second reagent inlets through the first and second reagent channels, and one third fluid from the first oil inlet through the first, second, third, and fourth oil channels; and step (c) includes collecting the droplets in the first and second collection reservoirs. In certain embodiments, the one or more sample inlets of the device include a first and a second sample inlet, the one or more reagent inlets of the device include a first and a second reagent inlet, the one or more oil inlets of the device include a first oil inlet, and the one or more collection reservoirs of the device include a first collection reservoir. The first and third sample channels are in fluid communication with the first sample inlet, the second and fourth sample channels are in fluid communication with the second sample inlet, the first reagent channel is in fluid communication with the first reagent inlet, and the second reagent channel is in fluid communication with the second reagent inlet. Step (b) then further includes flowing the one or more first fluids from the first and second sample inlets through the first, second, third, and fourth sample channels, the one or more second fluids from the first and second reagent inlets through the first and second reagent channels, and one third fluid from the first oil inlet through the first, second, third, and fourth oil channels.

In some embodiments of the method, the one or more reagent inlets of the device include a first and a second reagent inlet, and the one or more sample inlets include a first and a second sample inlet. The first reagent channel is in fluid communication with the first reagent inlet, the first sample channel is in fluid communication with the first sample inlet, the second reagent channel is in fluid communication with the second reagent inlet, the second sample channel is in fluid communication with the second sample inlet, and one or more of the first through fourth oil channels is disposed between the first and second reagent inlets and/or between the first and second sample inlets. Step (b) then further includes flowing the one or more first fluids from the first and second sample inlets through the first and second sample channels and the one or more second fluids from the first and second reagent inlets through the first and second reagent channels. In some embodiments, the one or more collection reservoirs of the device include first and second collection reservoirs. The first droplet channel is in fluid communication with the first collection reservoir, and the second droplet channel is in fluid communication with the second collection reservoir. Step (c) then further includes collecting the droplets in the first and second collection reservoirs. In certain embodiments, the device further includes a third sample channel in fluid communication with the first sample inlet and a fourth sample channel in fluid communication with the second sample inlet. The third sample channel intersects the first reagent channel at the first intersection and the fourth sample channel intersects the second reagent channel at the second intersection, and the third and fourth sample channels are disposed between the first and second reagent inlets. Step (b) then further includes flowing the one or more first fluids from the first and second sample inlets through the third and fourth sample channels and the one or more second fluids from the first and second reagent inlets through the third and fourth reagent channels. In some embodiments, the device further includes an oil waste reservoir and one or more oil waste channels, where each oil waste channel is in fluid communication with the oil waste reservoir and in fluid communication with the one or more collection reservoirs. Step (c) then further includes collecting oil in the oil waste reservoir.

In some embodiments of the method, the one or more collection reservoirs of the device include first and second collection reservoirs, the first droplet channel is in fluid communication with the first collection reservoir and the second droplet channel is in fluid communication with the second collection reservoir; where one or more of the first through fourth oil channels is disposed between the first and second collection reservoirs. Step (c) then further includes collecting the droplets in the first and second collection reservoirs.

In some embodiments of the method, at least one of the one or more sample channels and/or the one or more reagent channels includes one or more rectifiers and step (b) includes flowing the one or more first fluids and/or the one or more second fluids through the one or more rectifiers. In some embodiments, at least one of the one or more sample channels and/or the one or more reagent channels of the device includes a funnel and step (b) includes flowing the one or more first fluids and/or the one or more second fluids through the funnel. In some embodiments, the first fluid includes a plurality of biological particles, and at least a portion of the droplets collected in step (c) include at least one of the plurality of biological particles. In certain embodiments, the one or more first fluids includes a plurality of beads, and at least a portion of the droplets collected in step (c) include at least one of the plurality of beads.

Another aspect of the invention provides a system for producing droplets. The system includes (a) a device including a flow path including: i) one or more sample inlets; ii) one or more reagent inlets; iii) one or more oil inlets; iv) one or more collection reservoirs; v) a first and a second sample channel, each in fluid communication with the one or more sample inlets; vi) a first and a second reagent channel, each in fluid communication with the one or more reagent inlets; vii) a first, second, third, and fourth oil channel in fluid communication with the one or more oil inlets; viii) a first intersection at which the first reagent channel and the first sample channel intersect; ix) a second intersection at which the second reagent channel and the second sample channel intersect; x) a first and a second droplet channel, where the first droplet channel is in fluid communication with the first intersection and the one or more collection reservoirs and the second droplet channel is in fluid communication with the second intersection and the one or more collection reservoirs; xi) a third intersection at which the first and second oil channels and the first droplet channel intersect, where the third intersection is fluidically disposed between the first intersection and the one or more collection reservoirs; and xii) a fourth intersection at which the third and fourth oil channels and the second droplet channel intersect, where the fourth intersection is fluidically disposed between the second intersection and the one or more collection reservoirs; (b) one or more first fluids disposed in the first and second sample channels; (c) one or more second fluids disposed in the first and second reagent channels; (d) one or more third fluids disposed in the first, second third, and fourth oil channels; and (e) optionally particles in the one or more sample inlets and/or the one or more reagent inlets and droplets in the one or more collection reservoirs. The one or more first fluids and one or more second fluids are immiscible in the one or more third fluids, and the system is configured to produce droplets of the one or more first fluids and the one or more second fluids in the one or more third fluids.

In some embodiments of the system, the one or more sample inlets of the device include a first and a second sample inlet, the one or more reagent inlets of the device include a first reagent inlet, the one or more oil inlets of the device include a first oil inlet, the one or more collection reservoirs of the device include a first and a second collection reservoir. The first sample channel is in fluid communication with the first sample inlet, the second sample channel is in fluid communication with the second sample inlet, the first droplet channel is in fluid communication with the first collection reservoir, and the second droplet channel is in fluid communication with the second collection reservoir.

In some embodiments of the system, the one or more sample inlets of the device include a first sample inlet, the one or more reagent inlets of the device include a first reagent inlet, the one or more oil inlets of the device include a first and a second oil inlet, the one or more collection reservoirs of the device include a first collection reservoir; where the first and third oil channels are in fluid communication with the first oil inlet and the second and fourth oil channels are in fluid communication with the second oil inlet.

In some embodiments of the system, the device further includes a third and a fourth sample channel, each in fluid communication with the one or more sample inlets. The third sample channel intersects the first reagent channel at the first intersection, and the fourth sample channel intersects the second reagent channel at the second intersection; and one or more first fluids are disposed in the first and second sample channels. In certain embodiments, the one or more sample inlets of the device include a first and a second sample inlet, the one or more reagent inlets of the device include a first and a second reagent inlet, the one or more oil inlets of the device include a first oil inlet, and the one or more collection reservoirs of the device include a first and a second collection reservoir. The first and third sample channels are in fluid communication with the first sample inlet, the second and fourth sample channels are in fluid communication with the second sample inlet, the first reagent channel is in fluid communication with the first reagent inlet, the second reagent channel is in fluid communication with the second reagent inlet, the first droplet channel is in fluid communication with the first collection reservoir, and the second droplet channel is in fluid communication with the second collection reservoir. In particular embodiments, the one or more sample inlets of the device include a first and a second sample inlet, the one or more reagent inlets of the device include a first and a second reagent inlet, the one or more oil inlets of the device include a first oil inlet, and the one or more collection reservoirs of the device include a first collection reservoir. The first and third sample channels are in fluid communication with the first sample inlet, the second and fourth sample channels are in fluid communication with the second sample inlet, the first reagent channel is in fluid communication with the first reagent inlet, and the second reagent channel is in fluid communication with the second reagent inlet.

In some embodiments of the system, the one or more reagent inlets of the device include a first and a second reagent inlet, the one or more sample inlets include a first and a second sample inlet, the first reagent channel is in fluid communication with the first reagent inlet, the first sample channel is in fluid communication with the first sample inlet, the second reagent channel is in fluid communication with the second reagent inlet, the second sample channel is in fluid communication with the second sample inlet; and one or more of the first through fourth oil channels is disposed between the first and second reagent inlets and/or between the first and second sample inlets. In some embodiments, the one or more collection reservoirs of the device include first and second collection reservoirs. The first droplet channel is in fluid communication with the first collection reservoir, and the second droplet channel is in fluid communication with the second collection reservoir. In certain embodiments, the device further includes a third sample channel in fluid communication with the first sample inlet and a fourth sample channel in fluid communication with the second sample inlet. The third sample channel intersects the first reagent channel at the first intersection, and the fourth sample channel intersects the second reagent channel at the second intersection. The third and fourth sample channels are disposed between the first and second reagent inlets; and the system further includes one or more first fluids disposed in the first and second sample channels. In some embodiment, the device further includes an oil waste reservoir and one or more oil waste channels, where each oil waste channel is in fluid communication with the oil waste reservoir and in fluid communication with the one or more collection reservoirs.

In some embodiments, the one or more collection reservoirs of the device include first and second collection reservoirs, the first droplet channel is in fluid communication with the first collection reservoir, and the second droplet channel is in fluid communication with the second collection reservoir. One or more of the first through fourth oil channels is disposed between the first and second collection reservoirs.

In some embodiments, at least one of the one or more sample channels and/or the one or more reagent channels includes one or more rectifiers. In some embodiments, at least one of the one or more sample channels and/or the one or more reagent channels of the device includes a funnel. In some embodiments, the particles in the one or more sample inlets include biological particles. In some embodiments, the particles in the one or more reagent inlets include gel beads. In some embodiments, the device includes a plurality of flow paths.

In certain embodiments of any aspect described herein, sample channels and reagent channels do not intersect any other channel except as specifically described.

Devices may be multiplexed by including multiples of flow paths and/or various inlets and channels, e.g., arranged side by side, and as exemplified in the disclosure.

In any aspect described herein, adjacent inlets and channels may be in fluid communication with each other in certain embodiments. In particular, adjacent inlets or collection reservoirs may be connected by a trough or by a connecting channel. Adjacent inlets that are otherwise not in fluidic communication may also be controllable by the same pressure outlet, as described herein.

The invention also provides methods of producing droplets using any of the devices or systems described herein.

It will be understood, that although channels, reservoirs, and inlets are labeled as “sample” and “reagent” herein, each channel, reservoir, and inlet may be for either a sample or a reagent during use. In certain embodiments, sample channels, sample reservoirs, and sample inlets may be used as reagent channels, reagent reservoirs, and reagent inlets. In certain embodiments, reagent channels, reagent reservoirs, and reagent inlets may be used as sample channels, sample reservoirs, and sample inlets.

In embodiments of any aspect described herein, two or more sample channels or reagent channels in fluid communication with the same sample or reagent inlet may have substantially equal lengths, e.g., to maintain substantially equal fluidic resistance. For example, one sample or reagent channel may be at least 85% of the length of another sample or reagent channel in fluid communication with the same sample or reagent inlet, e.g., at least 90, 95, or 99% or 100% of the length of the other channel, and no greater than 150% of the length of the other channel, e.g., at most 115, 110, 105, or 101%. Alternatively, two or more sample channels or reagent channels in fluid communication with the same sample or reagent inlet may have, substantially equal fluidic resistance. For example, one sample or reagent channel may have at least 85% of the fluidic resistance of another sample or reagent channel in fluid communication with the same sample or reagent inlet, e.g., at least 90, 95, or 99% or 100% of the fluidic resistance of the other channel, and no greater than 115% of the fluidic resistance of another sample or reagent channel in fluid communication with the same sample or reagent inlet, e.g., at most 110, 105, or 101% or 100% of the fluidic resistance of the other channel

It will be understood, that all devices, methods, and systems described herein may be adapted to be compatible with a multi well plate layout, by making the inlets and reservoirs appropriately sized and spaced to be in a linear sequence according to a row or column of a multi-well plate, and that a plurality of any one of, or a combination of, the flow paths described herein can be arranged according to the multi well plate layout.

It will be understood that all methods described herein may produce droplets including non-biological particles and/or biological particles (e.g., cells or nuclei). In any aspect of the invention the first and/or third liquids can be aqueous, and the second liquid can be an oil. In any aspect of the invention, the first and/or third liquids can include a sample (e.g., biological particles, e.g., cells, nuclei, or particulate components thereof) or particles. For example, either the first or third liquid can include cells, and the other liquid can include particles. Cells/nuclei and particles can be combined in a droplet in any fashion, e.g., 1:1, 1:2. 1:3, or in non-integer ratios as an average for a distribution of droplets. In some embodiments, the droplets include particles and cells/nuclei in a 1:1 ratio.

In any aspect of the invention, one or more collection reservoirs may be omitted. For example, a collection reservoir may be replaced with an outlet, e.g., connected to tubing or another channel for delivery of droplets off the device.

### Definitions

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

The terms “adaptor(s),” “adapter(s),” and “tag(s)” may be used synonymously. An adaptor or tag can be coupled to a polynucleotide sequence to be “tagged” by any approach including ligation, hybridization, or other approaches.

The term “barcode,” as used herein, generally refers to a label, or identifier, that conveys or is capable of conveying information about an analyte. A barcode can be part of an analyte. A barcode can be a tag attached to an analyte (e.g., nucleic acid molecule) or a combination of the tag in addition to an endogenous characteristic of the analyte (e.g., size of the analyte or end sequence(s)). A barcode may be unique. Barcodes can have a variety of different formats. For example, barcodes can include polynucleotide barcodes; random nucleic acid and/or amino acid sequences; and synthetic nucleic acid and/or amino acid sequences. A barcode can be attached to an analyte in a reversible or irreversible manner. A barcode can be added to, for example, a fragment of a deoxyribonucleic acid (DNA) or ribonucleic acid (RNA) sample before, during, and/or after sequencing of the sample. Barcodes can allow for identification and/or quantification of individual sequencing-reads in real time.

The term “support,” as used herein, generally refers to a particle that is not a biological particle. The particle may be a solid or semi-solid particle. The particle may be a bead, such as a gel bead. The gel bead may include a polymer matrix (e.g., matrix formed by polymerization or cross-linking). The polymer matrix may include one or more polymers (e.g., polymers having different functional groups or repeat units). Polymers in the polymer matrix may be randomly arranged, such as in random copolymers, and/or have ordered structures, such as in block copolymers. Cross-linking can be via covalent, ionic, or inductive, interactions, or physical entanglement. The bead may be a macromolecule. The bead may be formed of nucleic acid molecules bound together. The bead may be formed via covalent or non-covalent assembly of molecules (e.g., macromolecules), such as monomers or polymers. Such polymers or monomers may be natural or synthetic. Such polymers or monomers may be or include, for example, nucleic acid molecules (e.g., DNA or RNA). The bead may be formed of a polymeric material. The bead may be magnetic or non-magnetic. The bead may be rigid. The bead may be flexible and/or compressible. The bead may be disruptable or dissolvable. The bead may be a solid particle (e.g., a metal-based particle including but not limited to iron oxide, gold or silver) covered with a coating comprising one or more polymers. Such coating may be disruptable or dissolvable.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) comprising a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or another organelle of a cell. A cell may be a live cell. The live cell may be capable of being cultured, for example, being cultured when enclosed in a gel or polymer matrix or cultured when comprising a gel or polymer matrix.

The term “canted”, as used herein, refers to a surface that is at an angle of less than 90° in relation to the horizontal plane.

The term “disposed radially about,” as used herein, refers to the location of two elements in relation to each other with a third element as a reference, such that the angle between the two elements is at least 5.0° (e.g., at least 8°, at least 10°, at least 15°, at least 20°, at least 30°, at least 40°, at least 50°, at least 60°, at least 70°, at least 80°, at least 90°, at least 100°, at least 110°, at least 120°, at least 130°, at least 140°, at least 150°, at least 160°, at least 170°, or 180°). In some instances, an angle between the two or more elements is between about 5° and about 180° (e.g., between about 10° and about 40°, between about 30° and about 70°, between about 50° and about 90°, between about 70° and about 110°, between about 90° and about 130°, between about 110° and about 150°, between about 130° and about 170°, or between about 135° and about 180°). In some instance, the two or more elements are substantially in line, i.e., within 5° radially.

The term “flow path,” as used herein, refers to a path of channels and other structures for liquid flow from at least one inlet to at least one outlet. A flow path may include branches and may connect to adjacent flow paths, e.g., by a common inlet or a connecting channel.

The term “fluidically connected,” as used herein, refers to a direct connection between at least two device elements, e.g., a channel, reservoir, etc., that allows for fluid to move between such device elements without passing through an intervening element.

The term “fluidically disposed between,” as used herein, refers to the location of one element between two other elements so that fluid can flow through the three elements in one direction of flow.

The term “funnel,” as used herein, refers to a channel portion having an inlet and an outlet in fluid communication with the inlet, and at least one cross-sectional dimension (e.g., width) between the inlet and outlet that is greater than the corresponding cross-sectional dimension (e.g., width) of the outlet. Funnels of the invention may be conical or pear-shaped (e.g., having an in-plane longitudinal cross-section of an isosceles trapezoid or hexagon). Funnels of the invention may have, e.g., an in-plane longitudinal cross-section of a trapezoid (e.g., an isosceles trapezoid), in which the smaller of the two bases corresponds to the funnel outlet. Alternatively, funnels of the invention may have, e.g., an in-plane longitudinal cross-section of a hexagon (e.g., a hexagon corresponding to two trapezoids fused at the greater of their bases, where the smaller of their bases correspond to the funnel inlet and outlet). For example, the leg of one trapezoid may be longer (e.g., at least 50% longer, at least 100% longer, at least 200% longer, at least 300% longer, at least 400% longer, or at least 500% longer; e.g., 1000% longer or less) than the leg of the other trapezoid in a funnel having an in-plane longitudinal cross-section of a hexagon. The sides in the trapezoid(s) may be straight or curved. The vertices of the trapezoid(s) may be sharp or rounded. Preferably, a funnel has two cross-sectional dimensions (e.g., width and depth) between the inlet and outlet that are greater than each of the corresponding cross-sectional dimensions (e.g., width and depth) of the outlet. Preferably, within a funnel, the maximum funnel width and the maximum funnel depth are located at the same distance from the inlet. Preferably, the depth and/or width maxima are closer to the funnel inlet than to the funnel outlet. A funnel may be a rectifier or mini-rectifier. Rectifiers are funnels having a length (i.e., the distance from the inlet to the outlet) of at least 10 times (e.g., at least 20 times, or at least 25 times) the smaller of the funnel outlet width, funnel outlet depth, funnel inlet width, and funnel inlet depth. Typically, a rectifier has a length that is 1,500% to 4,000% (e.g., 1,500% to 3,000%, 2,000% to 3,000%, or 2,500% to 3,000%) of the smaller of the funnel outlet width, funnel outlet depth, funnel inlet width, and funnel inlet depth. Mini-rectifiers are funnels having a length (i.e., the distance from the inlet to the outlet) of 10 times or less of the smaller of the funnel outlet width, funnel outlet depth, funnel inlet width, and funnel inlet depth. Typically, a mini-rectifier has a length that is 500% to 1,000% of the smaller of the funnel outlet width, funnel outlet depth, funnel inlet width, and funnel inlet depth.

The term “genome,” as used herein, generally refers to genomic information from a subject, which may be, for example, at least a portion or an entirety of a subject's hereditary information. A genome can be encoded either in DNA or in RNA. A genome can comprise coding regions that code for proteins as well as non-coding regions. A genome can include the sequence of all chromosomes together in an organism. For example, the human genome has a total of 46 chromosomes. The sequence of all of these together may constitute a human genome.

The term “hurdle,” as used herein, refers to a partial blockage of a channel or funnel that maintains the fluid communication between sides of the channel or funnel surrounding the blockage. Non-limiting examples of hurdles are pegs, barriers, and their combinations. A peg, or a row of pegs, is a hurdle having a height, width, and length, where the height is the greatest of the dimensions. A peg may be, for example, cylindrical. A barrier is a hurdle having a height, width, and length, where the width or length is the greatest of the dimensions. A barrier may be, for example, trapezoidal. In some embodiments, a peg has the same height as the channel or funnel, in which the peg is disposed. In certain embodiments, a barrier has the same width as the channel or funnel, in which the barrier is disposed. In particular embodiments, a barrier has the same length as the funnel, in which the barrier is disposed.

The term “in fluid communication with,” as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may comprise a nucleic acid. In some cases, the biological particle may be a macromolecule. The macromolecular constituent may comprise DNA or a DNA molecule. The macromolecular constituent may comprise RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may comprise a protein. The macromolecular constituent may comprise a peptide. The macromolecular constituent may comprise a polypeptide or a protein. The polypeptide or protein may be an extracellular or an intracellular polypeptide or protein. The macromolecular constituent may also comprise a metabolite. These and other suitable macromolecular constituents (also referred to as analytes) will be appreciated by those skilled in the art (see U.S. Pat. Nos. 10,011,872 and 10,323,278, and PCT Publication No. WO/2019/157529 each of which is incorporated herein by reference in its entirety).

The term “molecular tag,” as used herein, generally refers to a molecule capable of binding to a macromolecular constituent. The molecular tag may bind to the macromolecular constituent with high affinity. The molecular tag may bind to the macromolecular constituent with high specificity. The molecular tag may comprise a nucleotide sequence. The molecular tag may comprise an oligonucleotide or polypeptide sequence. The molecular tag may comprise a DNA aptamer. The molecular tag may be or comprise a primer. The molecular tag may be or comprise a protein. The molecular tag may comprise a polypeptide. The molecular tag may be a barcode.

The term “oil,” as used herein, generally refers to a liquid that is not miscible with water. An oil may have a density higher or lower than water and/or a viscosity higher or lower than water.

The term “particulate component of a cell,” as used herein, refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exome, a liposome, an endoplasmic reticulum (e.g., rough or smooth), a ribosome, a Golgi apparatus, a chloroplast, an endocytic vesicle, an exocytic vesicle, a vacuole, a lysosome or a mitochondrion.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. The sample may be a liquid sample, such as a blood sample, urine sample, or saliva sample. The sample may be a skin sample. The sample may be a cheek swap. The sample may be a plasma or serum sample. The sample may include a biological particle, e.g., a cell, a nucleus, or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). As an alternative, sequencing may be performed using nucleic acid amplification, polymerase chain reaction (PCR) (e.g., digital PCR, quantitative PCR, or real time PCR) or isothermal amplification. Such systems may provide a plurality of raw genetic data corresponding to the genetic information of a subject (e.g., human), as generated by the system from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “substantially linearly” means that a single, straight line can be drawn through the elements. The term does not require that the elements are centered with respect to the line that can be drawn.

The term “substantially stationary,” as used herein with respect to droplet or particle formation, generally refers to a state when motion of formed droplets or particles in the continuous phase is passive, e.g., resulting from the difference in density between the dispersed phase and the continuous phase.

By a “trough connecting” or similar language refers to a single fluidic chamber, i.e., the trough, that is in fluidic communication with the elements being connected. Thus, a single volume of liquid in a trough is divided, not necessarily equally, among the elements the trough connects. Furthermore, a trough may be disposed to be controllable by one or more pressure sources.

### BRIEF DESCRIPTION OF THE DRAWINGS

FIG. 1 is a schematic of a multiplex flow path with one oil inlet 0101, two sample inlets 0103, one reagent inlet 0104, and two collection reservoirs 0108.

FIG. 2 is a schematic of a multiplex flow path with two oil inlets 0201, one sample inlet 0203, one reagent inlet 0204, and one collection reservoir 0208.

FIGS. 3A and 3B are schematics of a multiplex flow path with one oil inlet 0301, two sample inlets 0303, two reagent inlets 0304, and two collection reservoirs 0308.

FIG. 4 is a schematic of a multiplex flow path with one oil inlet 0401, two sample inlets 0403, two reagent inlets 0404, and one collection reservoirs 0408.

FIGS. 5A-5C are schematics of multiplex flow paths with one oil inlet 0501, two sample inlets 0503, two reagent inlets 0504, and one (FIGS. 5A and 5B) or two (FIG. 5C) collection reservoir(s) 0508.

FIGS. 6A-6D are schematics of multiplex flow paths with one oil inlet 0601, two sample inlets 0603, two reagent inlets 0604, and one (FIG. 6A-6B) or two (6C-6D) collection reservoir(s) 0608. FIGS. 6B and 6D-6E also include an oil waste reservoir 609.

FIG. 7 is a schematic of a multiplex flow path with one oil inlet 0701, one sample inlet 0703, one reagent inlet 0704, and one collection reservoir 0708.

FIG. 8A is a top view of an exemplary funnel that may be included, e.g., at the proximal end of a sample or reagent channel. The funnel includes two rows of pegs as hurdles closer to the funnel inlet and a single row of pegs (in this instance, a single peg) closer to the funnel outlet.

FIG. 8B is a perspective view of an exemplary funnel shown in FIG. 8A.

FIG. 8C is a top view of an exemplary funnel that may be included, e.g., at the proximal end of a sample or reagent channel. The funnel includes a barrier with one row of pegs disposed on top of the barrier as hurdle.

FIG. 8D is a perspective view of an exemplary funnel shown in FIG. 8C.

FIG. 9A is a top view of an exemplary funnel that may be included, e.g., at the proximal end of a sample or reagent channel. The funnel includes a barrier with one row of pegs disposed on top of the barrier as hurdle. The pegs have a peg length that is greater than the peg width.

FIG. 9B is a perspective view of an exemplary funnel shown in FIG. 9A.

FIG. 9C is a top view of an exemplary funnel that may be included, e.g., at the proximal end of a sample or reagent channel. The funnel includes a barrier with one row of pegs disposed on top of the barrier as hurdle. The pegs have a peg length that is greater than the peg width.

FIG. 9D is a perspective view of an exemplary funnel shown in FIG. 9C.

FIG. 10A is a top view of an exemplary funnel that may be included, e.g., at the proximal end of a sample or reagent channel. The funnel includes a barrier with one row of pegs disposed along a curve on top of the barrier as hurdle.

FIG. 10B is a perspective view of an exemplary funnel shown in FIG. 10A.

FIG. 10C is a top view of an exemplary funnel that may be included, e.g., at the proximal end of a sample or reagent channel. The funnel includes a barrier with one row of pegs disposed on top of the barrier as hurdle. The pegs have a peg length that is greater than the peg width.

FIG. 10D is a perspective view of an exemplary funnel shown in FIG. 10C.

FIG. 10E is a top view of an exemplary funnel that may be included, e.g., at the proximal end of a sample or reagent channel. The funnel includes a barrier with one row of pegs disposed along a curve. The pegs have a peg length that is greater than the peg width. The funnel also includes a ramp.

FIG. 10F is a perspective view of an exemplary funnel shown in FIG. 10E.

FIG. 11A is a top view of an exemplary series of traps. In this figure, channel 1100 includes two traps 1107. The solid-fill arrow indicates the liquid flow direction through the channel including a series of traps.

FIG. 11B is a side view cross section of a channel including a trap. The trap has a length (L) and depth (h). In operation, air bubbles that might be carried with a liquid can be lifted by the air buoyancy and thus removed from the liquid flow.

FIG. 11C is a side view cross section of a channel including a trap. The trap has a length (L) and depth (h+50). In operation, air bubbles that might be carried with a liquid can be lifted by the air buoyancy and thus removed from the liquid flow.

FIG. 12A is a top view of an exemplary herringbone mixer. This herringbone mixer may be used to provide a single mix cycle in a channel. The herringbone mixer includes and grooves extending transversely across the channel. In this drawing, um stands for microns.

FIG. 12B is a side view cross section of an exemplary herringbone mixer portion shown in FIG. 12A. In this drawing, um stands for microns.

FIG. 12C is a top view of an exemplary herringbone mixer including twenty mix cycles assembled from herringbone mixers shown in FIG. 12A.

FIG. 13A is a side view cross section of a collection reservoir.

FIG. 13B is a side view cross section of a collection reservoir including a canted sidewall.

FIGS. 14A-14C are side view cross sections of exemplary collection reservoir including canted sidewalls.

FIG. 15 is a depiction of side view cross sections of exemplary collection reservoirs including canted sidewalls, an oblique circular cone shape, and a circular cone that tapers to a slot.

FIG. 16 is a depiction of side view cross sections of exemplary collection reservoir including canted sidewalls and slots, and slots with protrusions.

FIG. 17 is a depiction of side view cross sections of exemplary collection reservoirs or sample inlets.

FIG. 18 is a depiction of side view cross sections of exemplary collection reservoirs or sample inlets.

### DETAILED DESCRIPTION

The invention provides devices, systems, and methods for efficiently producing and collecting droplets. For example, devices and methods of the invention may be beneficial for the production and collection of high volumes of droplets or high frequencies of droplet production in a constrained area.

The devices, kits, systems, and methods of the invention may provide a plurality of droplets, in which majority of droplets are occupied by no more than one particle of the same type. In some cases, fewer than 25% of the occupied droplets contain more than one particle of the same type, and in many cases, fewer than 20% of the occupied droplets have more than one particle of the same type. In some cases, fewer than 10% or even fewer than 5% of the occupied droplets include more than one particle of the same type. In some cases, the devices, kits, systems, and methods of the invention may provide a plurality of droplets, in which majority of droplets are occupied by no more than one particle of one type (e.g., a bead) and one particle of another type (e.g., a biological particle).

It may also be desirable to avoid the creation of excessive numbers of empty droplets, for example, from a cost perspective and/or efficiency perspective. As such, at most about 95%, 90%, 85%, 80%, 75%, 70%, 65%, 60%, 55%, 50%, 45%, 40%, 35%, 30%, 25%, 20%, 15%, 10%, 5% or less of the generated droplets can be unoccupied. In some cases, the flow of one or more of the particles and/or liquids in the device can be conducted such that, in many cases, no more than about 50% of the generated droplets, no more than about 25% of the generated droplets, or no more than about 10% of the generated droplets are unoccupied. The above noted ranges of unoccupied droplets can be achieved while still providing any of the single occupancy rates described above. For example, in many cases, the devices, kits, systems, and methods of the invention produce droplets that have multiple occupancy rates of the same type of less than about 25%, less than about 20%, less than about 15%, less than about 10%, and, in many cases, less than about 5%, while having unoccupied droplets of less than about 50%, less than about 40%, less than about 30%, less than about 20%, less than about 10%, less than about 5%, or less.

The devices, kits, systems, and methods of the invention may provide droplets having substantially uniform distribution of dissolved ingredients (e.g., lysing reagents). In applications requiring controlled cell lysis, the devices, systems, and methods of the invention may also be used to reduce premature cell lysis (e.g., to reduce the extent of cell lysis in channels). For example, a combined stream of two partially unmixed liquids is formed by combining two liquids at a channel intersection. Without wishing to be bound by theory, the devices, kits, systems, and methods of the invention that include a mixer (e.g., a passive mixer) may pre-mix liquids (e.g., a third liquid and a fourth liquid or a third liquid and a first liquid) prior to droplet formation, thereby reducing localized high concentrations of dissolved ingredients (e.g., lysing reagents), which may cause premature cell lysis.

Additionally or alternatively, inclusion of funnels in sample channels may improve distribution uniformity by reducing the amount of debris entering the sample channel from the sample. In particular, this reduction in the amount of debris may reduce pressure fluctuations at a channel intersection, thereby improving the consistency in the mix ratio between liquids at the channel intersection. Thus, inclusion of funnels in sample channels may reduce the droplet-to-droplet content variation.

Additionally or alternatively, inclusion of traps in channels (e.g., a sample, reagent, or droplet channel) may improve uniformity by reducing the pressure fluctuations at a channel intersection by removing air bubbles from the liquid flow. Further, particle spacing uniformity may also be improved by removing air bubbles from the liquid flow. Thus, inclusion of traps in channels may reduce the droplet-to-droplet content variation.

### Devices and Systems

A device or system of the invention includes channels having a depth, a width, a proximal end, and a distal end. The proximal end is or is configured to be in fluid communication with a source of liquid, e.g., a reservoir integral to the device or coupled to the device, e.g., by tubing. The distal end is in fluid communication with, e.g., fluidically connected to, an intersection where the distal and/or proximal ends of other channels intersect.

The device includes one or more flow paths including reagent and sample channels, oil channels, and a droplet channel. A reagent channel and a sample channel intersect at a droplet channel, which in turn intersects with oil channels. The proximal ends of the sample and or reagent channels are in fluid communication with, e.g., fluidically connected to, one or more sample and/or reagent inlets or reservoirs. The proximal ends of the oil channels are in fluid communication with, e.g., fluidically connected to, one or more oil inlets or reservoirs. The distal end of the droplet channel is in fluid communication with, e.g., fluidically connected to, a collection reservoir.

As one or more liquids, e.g., the combination of a sample and a reagent liquid, flow into an intersection via a droplet channel, oil from the oil channels flows around the liquid, causing it to divide to form a plurality of droplets, which flow to a collection reservoir via the droplet channel. Such an arrangement is an embodiment of a cross-junction type flow focusing intersection. Examples of other intersections that can be used in this invention are described in U.S. Pat. Nos. 9,694,361 and 10,725,027, the intersections of which are incorporated by reference herein. Examples of intersections also include, e.g., a T-junction, a Y-junction, a channel-within-a-channel junction, a cross (or “X”) junction, and a flow-focusing junction.

The depth and width of a channel may be the same, or one may be larger than the other, e.g., the width is larger than the depth, or depth is larger than the width. In some embodiments, the depth and/or width is between about 0.1 μm and 1000 μm. In some embodiments, the depth and/or width of the channel is from 1 to 750 μm, 1 to 500 μm, 1 to 250 μm, 1 to 100 μm, 1 to 50 μm, or 3 to 40 μm. In certain embodiments, the depth and/or width of the channel is 10 μm to 100 μm. In some cases, when the width and length differ, the ratio of the width to depth is, e.g., from 0.1 to 10, e.g., 0.5 to 2 or greater than 3, such as 3 to 10, 3 to 7, or 3 to 5. The width and depths of a channel may or may not be constant over its length. Funnels may be used to control particle (e.g., bead) flow, e.g., to provide evenly spaced particles (e.g., beads). In some cases, a reagent channel may include one or more funnels, each funnel having a funnel proximal end, a funnel distal end, a funnel width, and a funnel depth, and each funnel proximal end has a funnel inlet, and each funnel distal end has a funnel outlet. In some cases, a reagent channel includes 1 to 5 (e.g., 1 to 4, 1 to 3, 1 to 2, or 1) funnel(s). For example, a reagent channel may include 1, 2, 3, 4, or 5 funnel(s). In some cases, at least one funnel is a mini-rectifier. In some cases, at least one funnel is a rectifier. For example, a reagent channel may include 1, 2, or 3 rectifiers and 1, 2, or 3 mini-rectifiers.

In some cases, a sample channel may include one or more funnels, each funnel having a funnel proximal end, a funnel distal end, a funnel width, and a funnel depth, and each funnel proximal end has a funnel inlet, and each funnel distal end has a funnel outlet. In some cases, a sample channel includes 1 to 5 (e.g., 1 to 4, 1 to 3, 1 to 2, or 1) funnel(s). For example, a sample channel may include 1, 2, 3, 4, or 5 funnel(s). In some cases, at least one funnel is a mini-rectifier. In some cases, at least one funnel is a rectifier. For example, a sample channel may include 1, 2, or 3 rectifiers and 1, 2, or 3 mini-rectifiers.

One or more funnels may include hurdle(s) (e.g., 1, 2, or 3 hurdles in one funnel). The hurdle may be a row of pegs, a barrier, or a combination thereof. The hurdles may be disposed anywhere within the funnel, e.g., closer to the funnel inlet, closer to the funnel outlet, or in the middle. Typically, when rows of pegs are included in the funnel, at least two rows of pegs are included. Pegs may have a diameter of 40 μm to 100 μm (e.g., 50 μm to 100 μm, 60 μm to 100 μm, 70 μm to 100 μm, 80 μm to 100 μm, 90 μm to 100 μm, 40 μm to 90 μm, 50 μm to 90 μm, 60 μm to 90 μm, 70 μm to 90 μm, 80 μm to 90 μm, 40 μm to 80 μm, 50 μm to 80 μm, 60 μm to 80 μm, 70 μm to 80 μm, 40 μm to 70 μm, 50 μm to 70 μm, or 60 μm to 70 μm). Pegs may have a width of 40 μm to 100 μm (e.g., 50 μm to 100 μm, 60 μm to 100 μm, 70 μm to 100 μm, 80 μm to 100 μm, 90 μm to 100 μm, 40 μm to 90 μm, 50 μm to 90 μm, 60 μm to 90 μm, 70 μm to 90 μm, 80 μm to 90 μm, 40 μm to 80 μm, 50 μm to 80 μm, 60 μm to 80 μm, 70 μm to 80 μm, 40 μm to 70 μm, 50 μm to 70 μm, or 60 μm to 70 μm). Pegs may have a peg length and a peg width, and the peg length may be greater than the peg width (e.g., the peg length may be at least 10%, 25%, 50%, 75%, 100%, 150%, 200%, or 300% greater than the peg width; e.g., the peg length may be 10% to 1000%, 10% to 900%, 10% to 800%, 10% to 700%, 10% to 600%, 50% to 1000%, 50% to 900%, 50% to 800%, 50% to 700%, 50% to 600%, 100% to 1000%, 100% to 900%, 100% to 800%, 100% to 700%, 100% to 600%, 200% to 1000%, 200% to 900%, 200% to 800%, 200% to 700%, or 200% to 600% greater than the peg width). Individual pegs may be spaced at a distance sized to allow at least one particle through the row of pegs (e.g., the distance between individual pegs may be 100% to 500% of the particle diameter). For example, the distance between individual pegs may be at least same as the diameter of a particle (e.g., 100% to 1000% of the particle diameter, 100% to 900% of the particle diameter, 100% to 800% of the particle diameter, 100% to 700% of the particle diameter, 100% to 600% of the particle diameter, or 100% to 500% of the particle diameter), for which the funnel is configured. For example, individual pegs may be spaced at 50 μm to 100 μm (e.g., 60 μm to 100 μm, 70 μm to 100 μm, 80 μm to 100 μm, 90 μm to 100 μm, 50 μm to 90 μm, 60 μm to 90 μm, 70 μm to 90 μm, 80 μm to 90 μm, 50 μm to 80 μm, 60 μm to 80 μm, 70 μm to 80 μm, 50 μm to 70 μm, 60 μm to 70 μm, or 50 μm to 60 μm) from each other. A barrier may have a height that leaves space between the barrier and the opposite funnel wall sized to permit a particle through the space (e.g., the height between the barrier and the funnel wall may be 50% to 400% of the particle diameter). For example, the height between the barrier and the funnel wall may be at least 50% of the particle diameter, for which the funnel is configured (e.g., at least 60%, at least 70%, at least 80%, at least 90%, at least 100% of the particle diameter; e.g., 400% or less, 300% or less, 200% or less of the particle diameter). The barrier may have a height that is at least 100% of the particle diameter, for which the funnel is configured (e.g., at least 200%, at least 300%, at least 400%, at least 500%, at least 600%, or at least 700% of the particle diameter; 800% or less, 700% or less, 600% or less, 500% or less, 400% or less, 300% or less, 200% or less of the particle diameter). A barrier may have a height of at least 20 μm (e.g., at least 30 μm, at least 40 μm, at least 50 μm, or at least 60 μm). For example, a barrier may have a height of 20 μm to 70 μm (e.g., 30 μm to 70 μm, 40 μm to 70 μm, 50 μm to 70 μm, 60 μm to 70 μm, 20 μm to 60 μm, 30 μm to 60 μm, 40 μm to 60 μm, 50 μm to 60 μm, 20 μm to 50 μm, 30 μm to 50 μm, 40 μm to 50 μm, 20 μm to 40 μm, 30 μm to 40 μm, or 20 μm to 30 μm).

Sample channels can intersect reagent channels at any suitable angle, e.g., between 5° and 135° relative to the centerline of the reagent channel, such as between 75° and 115° or 85° and 95°. Droplet channels can intersect oil channels at any suitable angle, e.g., between 5° and 135° relative to the centerline of the oil channel, such as between 75° and 115° or 85° and 95°. Droplet channels can intersect sample and/or reagent channels at any suitable angle, e.g., between 5° and 135° relative to the centerline of the sample or reagent channel, such as between 75° and 115° or 85° and 95°. Additional channels may similarly be present to allow introduction of further liquids or additional flows of the same liquid. Multiple channels can intersect the reagent channel on the same side or different sides of the reagent channel. In some instances, a channel configured to direct a liquid comprising a plurality of particles may include one or more grooves in one or more surface of the channel to direct the plurality of particles towards the intersection. For example, such guidance may increase single occupancy rates of the generated droplets. Additional channels may have any of the structural features discussed above for the sample, reagent, droplet, or oil channels.

Devices may include multiple flow paths, e.g., to increase the rate of droplet formation. In general, throughput may significantly increase by increasing the number of intersections of droplet channels and oil channels of a device. For example, a device having five intersections may generate five times as many droplets than a device having one intersection, provided that the liquid flow rate is substantially the same. A device may have as many intersections as is practical and allowed for the size of the source of liquid, e.g., reservoir. For example, the device may have at least about 2, 3, 4, 5, 6, 7, 8, 9, 10, 20, 30, 40, 50, 60, 70, 80, 90, 100, 150, 200, 250, 300, 350, 400, 450, 500, 600, 700, 800, 900, 1000, 1500, 2000 or more intersections. Inclusion of multiple intersections may require the inclusion of channels that traverse but do not intersect, e.g., the flow path is in a different plane. Multiple flow paths may be in fluid communication with, e.g., fluidically connected to, a separate source reservoir/inlet (e.g., a sample inlet and/or reagent inlet) and/or a separate intersection. In other embodiments, two or more channels are in fluid communication with, e.g., fluidically connected to, the same fluid source, e.g., where the multiple reagent channels branch from a single, upstream inlet or channel. Alternatively or in addition, droplet formation can be increased by increasing the flow rate of the sample liquid and/or reagent liquid. In some cases, the throughput of droplet formation can be increased by having a plurality of single droplet forming flow paths in a single device, e.g., parallel droplet formation.

The devices, kits, systems, and methods of the invention may include a mixer. The mixer may be included downstream of an intersection where two different liquids from two intersecting channels are combined. Any sample, reagent, and/or droplet channel may include a mixer, e.g., a passive mixer (e.g., a chaotic advection mixer). The mixer may be included downstream of an intersection between the sample and reagent channels, e.g., in the droplet channel.

Mixers that may be included in the devices and systems of the invention are known in the art. Non-limiting examples of mixers include a herringbone mixer, connected-groove mixer, modified staggered herringbone mixer, wavy-wall channel mixer, chessboard mixer, alternate-injection mixer with an increased cross-section chamber, serpentine laminating micromixer, two-layer microchannel mixer, connected-groove micromixer, and SAR mixer. Non-limiting examples of mixers are described in Suh and Kang, Micromachines, 1:82-111, 2010; Lee et al., Int. J. Mol. Sci., 12:3263-3287, 2011; and Lee et al., Chem. Eng. J., 288:146-160, 2016. Typically, the mixer may be sized to accommodate particles passing through (e.g., biological particles, such as cells, nuclei, or particulate components thereof). The mixer may have a length of 2-15 mm (e.g., 2, 3, 4, 5, 6, 7, 8, 9, 10, 11, 12, 13, 14, or 15 mm).

Alternatively or additionally, the device may include one or more traps in channels. The traps may be included in channels in a configuration that permits air buoyancy to raise any bubbles away from the liquid flow. Thus, a trap typically has a trap depth that is greater than the depth of the channel, in which the trap is disposed. One of skill in the art will recognize that the terms depth and height may be used interchangeably to indicate the same dimension.

In general, droplet formation includes two liquid phases. The two phases may be, for example, an aqueous phase and an oil phase. During droplet formation, a plurality of discrete volume droplets is formed.

Discrete liquid droplets may be encapsulated by a carrier fluid (e.g., the oil) that wets the microchannel. In T junctions, the disperse phase and the continuous phase are injected from two branches of the “T”. Droplets of the disperse phase are produced as a result of the shear force and interfacial tension at the fluid-fluid interface. The phase that has lower interfacial tension with the channel wall is the continuous phase. To generate droplets in a flow-focusing configuration, the continuous phase (e.g., oil) is injected through two outside channels and the dispersed phase (e.g., the combined sample and reagent fluid flow) is injected through a central channel into a narrow orifice. An example of flow-focusing droplet forming architecture is a cross junction, where another channel provides an outlet for the combined flow of the dispersed and continuous phases. Other geometric designs to create droplets would be known to one of skill in the art. Methods of producing droplets are disclosed in Song et al. Angew. Chem. 45: 7336-7356, 2006, Mazutis et al. Nat. Protoc. 8(5):870-891, 2013, U.S. Pat. No. 9,839,911; U.S. Pub. Nos. 2005/0172476, 2006/0163385, and 2007/0003442, PCT Pub. Nos. WO 2009/005680 and WO 2018/009766.

The device may also include reservoirs for liquid reagents. For example, the device may include a reservoir for the liquid to flow in the reagent or sample channels and/or a reservoir for collection. Similarly, a reservoir for liquids to flow in additional channels, such as the oil channels intersecting the droplet channel may be present. A single reservoir may also be connected to multiple channels in a device, e.g., when the same liquid is to be introduced at two or more different locations in the device (e.g., the two oil channels that intersect the droplet channel, or third and fourth oil channels that intersect a second droplet channel). Waste reservoirs (e.g., oil waste reservoirs) or overflow reservoirs may also be included to collect waste or overflow when droplets are formed, e.g., to accommodate excess oil, e.g., to allow more oil to be used than can be accommodated in, e.g., the one or more collection reservoirs. An oil waste reservoir may be connected to one or several collection reservoirs, e.g., by one or more oil waste channels. Oil waste reservoirs may act to prevent or reduce oil push-back, e.g., push-back into the droplet forming junctions. Alternatively, the device may be configured to mate with sources of the liquids, which may be external reservoirs such as vials, tubes, or pouches. Similarly, the device may be configured to mate with a separate component that houses the reservoirs. Reservoirs may be of any appropriate size, e.g., to hold 10 μL to 500 mL, e.g., 10 μL to 300 mL, 25 μL to 10 mL, 100 μL to 1 mL, 40 μL to 300 μL, 1 mL to 10 mL, or 10 mL to 50 mL. When multiple reservoirs are present, each reservoir may have the same or a different size.

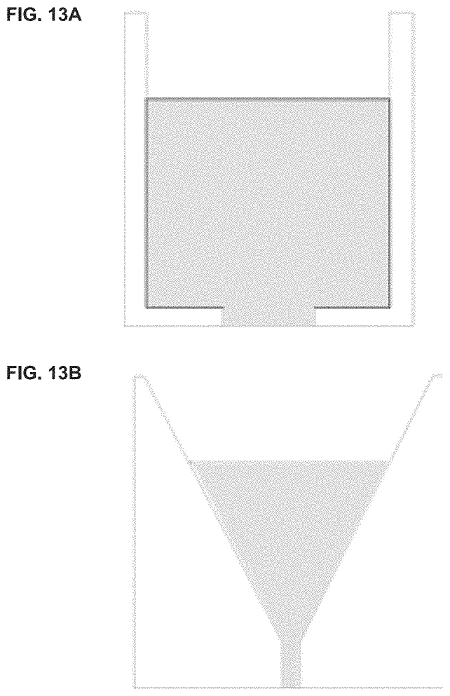

In some instances, reservoirs, e.g., oil reservoirs, collection reservoirs, sample reservoirs, and/or reagent reservoirs, may hold about 10 μL to about 1 ml, e.g., about 10 μL to about 500 μL, about 10 μL to about 750 μL, about 10 μL to about 50 μL, about 40 μL to about 80 μL, about 20 μL to about 100 μL, about 70 μL to about 100 μL, about 90 μL to about 120 μL, about 110 μL to about 150 μL, about 140 μL to about 190 about μL, about 180 μL to about 220 μL, about 210 μL to about 250 μL, about 240 μL to about 280 μL, about 270 μL to about 340 μL, about 330 μL to about 345 μL, about 340 μL to about 375 μL, about 370 μL to about 420 μL, about 410 μL to about 470 μL, or about 460 μL to about 500 μL. In some instances, the reservoirs may hold about 480 μL, about 340 μL, about 280 μL, about 220 μL, about 110 μL or about 80 μL. Typically, the volume of the collection reservoir is equal to or greater than the volumes of the sample, reagent, and oil reservoirs (or portions thereof) that empty into it. Exemplary device reservoir designs are depicted in FIGS. 13-18.

In some instances, the reservoirs are filled between 20% and 98% of the volume, e.g., about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, or 98%. In some instances, the reservoirs are filled between 20% and 35%, between 30% and 45%, between 40% and 55%, between 50% and 65%, between 60% and 75%, between 70% and 85%, between 80% and 95%, or between 90% and 98%.

Alternatively or in addition, reservoirs, e.g., oil reservoirs, collection reservoirs, sample reservoirs, and/or reagent reservoirs, may include a side wall canted between a 89.5° and 4° angle, e.g., between a 85° and 5° angle, e.g., about a 89°, 88°, 87°, 86°, 85°, 84°, 83°, 82°, 81°, 80°, 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, or 5° angle. In some instances, the side wall is canted between 85° and 70°, between 75° and 60°, between 65° and 50°, between 55° and 48°, between 50° and 43°, between 46° and 44°, between 44° and 35°, between 37° and 25°, between 30° and 15°, or between 20° and 5°. In certain embodiments, the side wall may be canted at two or more angles at various vertical heights. In other embodiments, the side wall is canted for a portion of the height and vertical for a portion of the height. For example, the side wall may be canted for 5-100% of the height, e.g., for 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%. In some instances, the side wall may be canted for between 100% and 85%, between 100% and 75%, between 100% and 50%, between 90% and 75%, between 80% and 65%, between 70% and 55%, between 60% and 45%, between 50% and 35%, between 50% and 5%, between 40% and 25%, between 30% and 15%, or between 20% and 5%. When the side wall is canted at two or more angles, the canted portions may have the same vertical height or different vertical heights. For example, for two canted portions, the higher angled portion may be between 5 to 95% of the canted portion of the side wall, e.g., 5 to 75% 5 to 50%, 5 to 25%, 50 to 95%, 50 to 75%, 75 to 95%, 25 to 75%, 25 to 50%, or 40 to 60%.

Alternatively, or in addition, reservoirs, e.g., oil reservoirs, collection reservoirs, sample reservoirs, and/or reagent reservoirs, may include canted sidewalls, slots, and slots with protrusions, i.e., expanding the opening of the slot, at the interface between the reservoir and the channel. In some embodiments, the canted sidewalls are an oblique circular cone shape, a circular cone that tapers to a slot, or a circular cone that tapers to a slot with protrusions at the interface between the reservoir and the channel. Exemplary device reservoir designs are depicted in FIGS. 13-18.

The vertical height of a reservoir, e.g., oil reservoir, collection reservoir, sample reservoir, waste reservoir, and/or reagent reservoir, may be between 1 and 20 mm, e.g., 1 to 5 mm, 1 to 10 mm, 1 to 15 mm, 5 to 10 mm, 5 to 15 mm, 10 to 22 mm, 2 to 7 mm, 7 to 13 mm, 12 to 18 mm or at least 5, at least 10, or at least 15 mm.

A collection reservoir may contain an oil that is continuously circulated, e.g., using a paddle mixer, conveyor system, or a magnetic stir bar. Alternatively, the collection reservoir may contain one or more reagents for chemical reactions that can provide a coating on the droplets to ensure isolation, e.g., polymerization, e.g., thermal- or photo-initiated polymerization.

In addition to the components discussed above, devices of the invention can include additional components.

For example, channels may include filters to prevent introduction of debris into the device. In some cases, the microfluidic systems described herein may comprise one or more liquid flow units to direct the flow of one or more liquids, such as the sample and/or reagent liquid and/or the oil. In some instances, the liquid flow unit may comprise a compressor to provide positive pressure at an upstream location to direct the liquid from the upstream location to flow to a downstream location. In some instances, the liquid flow unit may comprise a pump to provide negative pressure at a downstream location to direct the liquid from an upstream location to flow to the downstream location. In some instances, the liquid flow unit may comprise both a compressor and a pump, each at different locations. In some instances, the liquid flow unit may comprise different devices at different locations. The liquid flow unit may comprise an actuator. Devices may also include various valves to control the flow of liquids along a channel or to allow introduction or removal of liquids or droplets from the device. Suitable valves are known in the art. Valves useful for a device of the present invention include diaphragm valves, solenoid valves, pinch valves, or a combination thereof. Valves can be controlled manually, electrically, magnetically, hydraulically, pneumatically, or by a combination thereof. The device may also include integral liquid pumps or be connectable to a pump to allow for pumping in the sample or reagent channels and any other channels requiring flow. Examples of pressure pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single device. The device may also include one or more vents to allow pressure equalization, and one or more filters to remove particulates or other undesirable components from a liquid. The device may also include one or more inlets and or outlets, e.g., to introduce liquids and/or remove droplets. Such additional components may be actuated or monitored by one or more controllers or computers operatively coupled to the device, e.g., by being integrated with, physically connected to (mechanically or electrically), or by wired or wireless connection.

In some instances, a fluid may include suspended particles. The particles may be beads, biological particles, cells, nuclei, cell beads, or any combination thereof (e.g., a combination of beads and cells or nuclei or a combination of beads and cell beads, etc.). A discrete droplet generated may include a particle, such as when one or more particles are suspended in the volume of the first fluid that is propelled into the second fluid. Alternatively, a discrete droplet generated may include more than one particle. Alternatively, a discrete droplet generated may not include any particles. For example, in some instances, a discrete droplet generated may contain one or more biological particles where the first fluid in the sample channel includes a plurality of biological particles.

Droplets or particles may be first formed, added to, or collected in a larger volume, such as in a reservoir, and then subjected to unit operations, such as trapping, holding, incubation, reaction, emulsion breaking, sorting, and/or detection. This method may include detecting the droplets, e.g., as they are formed or while traversing a subsequent region downstream. The device may further include additional regions, e.g., reservoirs, for manipulation, e.g., holding, incubation, reaction, or deemulsification.

### Multiplex Devices

Devices of the invention may be in multiplex format. Multiplex formats include devices having multiple intersections of droplet channels and oil channels downstream from a single sample inlet and/or reagent inlet, multiple parallel flow paths with a sample inlet and an intersection, and combinations thereof. The flow paths, e.g., channels, inlets, reservoirs, funnels, filters, and intersections, etc., may be any as described herein. Inlets in multiplex devices may include a simple opening to allow introduction of fluid, or an inlet may be a chamber or reservoir housing a volume of fluid to be distributed (e.g., corresponding to an oil reservoir or sample, reagent, or collection reservoir as described herein).

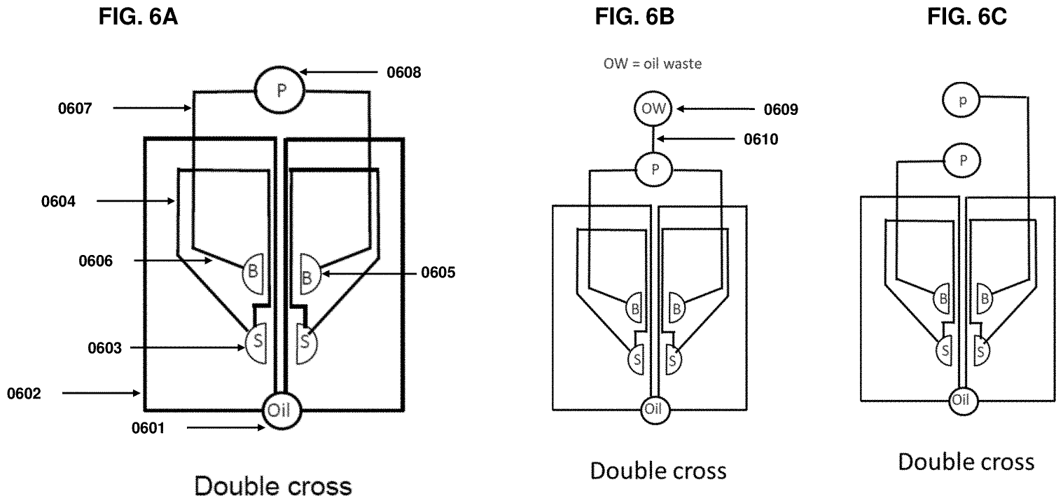

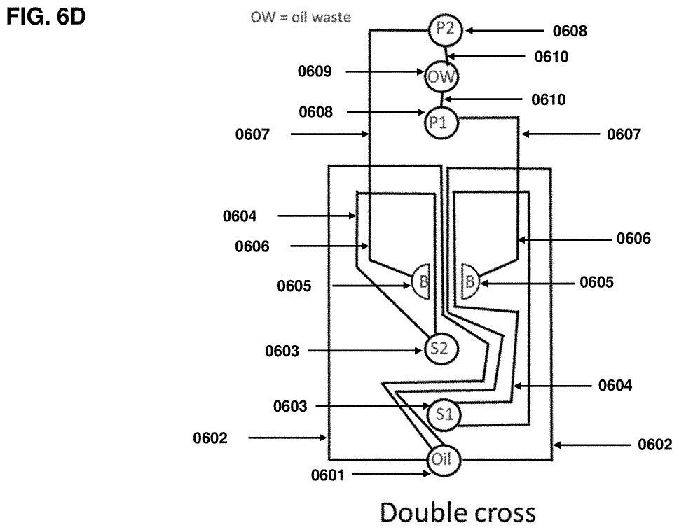

In one embodiment, the multiplex devices include one or more sample inlets, one or more reagent inlets, one or more oil inlets, and one or more collection reservoirs. The one or more sample inlets, one or more reagent inlets, one or more oil inlets, and one or more collection reservoirs are placed in fluid communication by channels. A channel from the sample inlet intersects a channel from the reagent inlet at an intersection with a droplet channel. Fluids flowing from the sample and reagent inlets combine in the droplet channel. Two channels from the oil inlet intersect the droplet channel at a second intersection. Droplets of the combined sample and reagent fluids form at the second intersection. A single channel coming from an inlet may split into two or more branches, each of which may intersect another channel (or branch). Multiplex devices may include multiple multiplex flow paths. Each multiplex flow path may be fluidically distinct or connected to other flow paths. For example, multiple flow paths may share a collection reservoir. In certain embodiments, a single reagent inlet delivers, via different reagent channels or different branches of a reagent channel, reagent to intersections with sample channels from different sample inlets. In the alternative or in addition, sample, oil, and/or reagent inlets may be connected by troughs (see, e.g., FIG. 6E). Where flow paths share a common inlet, outlet, or reservoir, the flow paths may be disposed radially about the common inlet, outlet, or reservoir. In some instances, devices described herein contain between 1 and 30 flow paths (e.g., at least 2, at least 4, at least 8, or 1, 2, 3, 4, 5, 6, 7, 8, 9, 10, 11, 12, 13, 14, or 15 flow paths). In some instances, devices described herein may feature troughs that connect inlets or collection reservoirs, e.g., a trough may connect between 1 and 30 inlets or collection reservoirs of the same and/or different flow paths (e.g., at least 2, at least 4, at least 8, or 1, 2, 3, 4, 5, 6, 7, 8, 9, 10, 11, 12, 13, 14, or 15 inlets or collection reservoirs of multiple flow paths).

For multiplex devices including multiple multiplex flow paths, the same or different samples can be introduced in different flow paths, and/or the same or different reagents can be introduced in different flow paths. For devices including flow paths, wherein the flow paths include multiple sample or reagent inlets, the same or different samples and/or reagents can be introduced in the inlets.

Combinations of different flow paths may be combined in a single multiplex device. Multiplex devices may also include common inlets, which may be an oil inlet, a sample inlet, a reagent inlet, or a collection reservoir. In such devices, additional inlets may be disposed around the common inlet.

Inlets of the same type and/or collection reservoirs may be arranged substantially linearly, e.g., for ease of deliver or removal of fluids from the device by a multichannel pipette. Linear arrangement also allows for a more compact trough design when employed.

Multiplex devices may include a plurality of inlets surrounded by at least one common wall and have a dividing wall that has at least a portion of the dividing wall that is shorter than the one common wall. This arrangement allows a single pressure source to control fluid flow in two different inlets.

Multiplex devices may include multiplex flow path having either i) a connecting channel in fluid communication with two or more oil, sample or reagent inlets or two or more oil, sample, or reagent channels, or ii) one oil, sample, or reagent channel that combines with another oil, sample, or reagent channel for a distance before splitting into two separate oil, sample, or reagent channels, as described herein.

Multiplex devices for producing droplets may include a) one or more sample inlets; b) one or more reagent inlets; c) one or more oil inlets; d) one or more collection reservoirs; e) a first and a second sample channel, each in fluid communication with the one or more sample inlets; f) a first and a second reagent channel, each in fluid communication with the one or more reagent inlets; g) a first, second, third, and fourth oil channel in fluid communication with the one or more oil inlets; h) a first intersection at which the first reagent channel and the first sample channel intersect; i) a second intersection at which the second reagent channel and the second sample channel intersect; j) a first and a second droplet channel, where the first droplet channel is in fluid communication with the first intersection and the one or more collection reservoirs and the second droplet channel is in fluid communication with the second intersection and the one or more collection reservoirs; k) a third intersection at which the first and second oil channels and the first droplet channel intersect, where the third intersection is fluidically disposed between the first intersection and the one or more collection reservoirs; and l) a fourth intersection at which the third and fourth oil channels and the second droplet channel intersect, where the fourth intersection is fluidically disposed between the second intersection and the one or more collection reservoirs, and provided that the one or more sample inlets includes at least two sample inlets or the one or more reagent inlets includes at least two reagents inlets.

The maximum cross sectional dimension of the sample channels may be 250 μm, e.g., about 1 μm, about 5 μm, about 10 μm, about 20 μm, about 30 μm, about 40 μm, about 50 μm, about 60 μm, about 70 μm, about 80 μm, about 90 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 247 μm, about 248 μm, about 249 μm, e.g., between about 1 μm to about 20 μm, about 10 μm to about 30 μm, about 20 μm to about 40 μm, about 30 μm to about 50 μm, about 40 μm to about 60 μm, about 50 μm to about 70 μm, about 60 μm to about 80 μm, about 70 μm to about 90 μm, about 80 μm to about 100 μm, about 90 μm to about 110 μm, about 100 μm to about 120 μm, about 110 μm to about 130 μm, about 120 μm to about 140 μm, about 130 μm to about 150 μm, about 140 μm to about 160 μm, about 150 μm to about 170 μm, about 160 μm to about 180 μm, about 170 μm to about 190 μm, about 180 μm to about 200 μm, about 190 μm to about 210 μm, about 200 μm to about 220 μm, about 210 μm to about 230 μm, about 220 μm to about 240 μm, or about 230 μm to about 245 μm. In some instances, the maximum cross-sectional dimension of the reagent channels is about 250 μm, e.g., about 1 μm, about 5 μm, about 10 μm, about 20 μm, about 30 μm, about 40 μm, about 50 μm, about 60 μm, about 70 μm, about 80 μm, about 90 μm, about 100 μm, 1 about 05 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 247 μm, about 248 μm, about 249 μm, e.g., between about 1 μm to about 20 μm, about 10 μm to about 30 μm, about 20 μm to about 40 μm, about 30 μm to about 50 μm, about 40 μm to about 60 μm, about 50 μm to about 70 μm, about 60 μm to about 80 μm, about 70 μm to about 90 μm, about 80 μm to about 100 μm, about 90 μm to about 110 μm, about 100 μm to about 120 μm, about 110 μm to about 130 μm, about 120 μm to about 140 μm, about 130 μm to about 150 μm, about 140 μm to about 160 μm, about 150 μm to about 170 μm, about 160 μm to about 180 μm, about 170 μm to about 190 μm, about 180 μm to about 200 μm, about 190 μm to about 210 μm, about 200 μm to about 220 μm, about 210 μm to about 230 μm, about 220 μm to about 240 μm, or about 230 μm to about 245 μm. In some instances, the maximum cross-sectional dimension of the reagent channels is between about 10 μm and about 150 μm, between about 50 μm and about 150 μm, between about 80 μm and about 200 μm, or between about 100 μm and about 250 μm.

Advantageously, multiplexed devices of the invention may be compatible with equipment for use with multi-well plates, e.g., 96 well plates, 384 well plates, or 1536 well plates. Sizing and spacing the inlets and reservoirs of the multiplexed devices described herein to be in a linear sequence according to a row or column of a multi well plate allows the inlets to be filled or collection reservoirs emptied using multichannel pipettors, improving the efficiency of these steps. In another advantage, the multiplexed devices being sized and spaced to be in a linear sequence according to a row or column of a multi-well plate allow integration with robotic laboratory automation such as robotic plate handlers, samplers, analyzers, and other high-throughput systems adapted for multi well plate operations. Multiplexed devices of the invention can be disposed to fit a 96 well plate, a 384 well plate, or a 1536 well plate format. While it is preferable that the inlets and reservoirs of the multiplexed devices are arranged substantially linearly in order to maximize packing of flow paths into the area of a multi well plate, it is also possible for non-linear flow paths, and other non-linear arrangements of inlets and reservoirs, as described herein to be adapted to fit into a multi well plate format. In some embodiments, the number of flow paths possible in a multi well plate format is the number of wells of the multi well plate divided by the sum of the reservoirs and inlets in the flow path, provided the reservoirs and inlets are arranged substantially linearly. For example, for a flow path with three inlets and one collection reservoir, arranged substantially linearly, in a 96 well plate format the number of flow paths is 24. In some instances, the multiplexed devices described herein contain between 1 and 24 flow paths (e.g., up to 12, up to 13, up to 16, up to 19, or up to 24). In some instances, the multiplexed devices described herein contain between 1 and 96 flow paths (e.g., up to 36, up to 40, up to 48, up to 57, or up to 96). In some instances, the multiplexed devices described herein contain between 1 and 384 flow paths (e.g., up to 144, up to 164, up to 192, up to 230, or up to 288). Arrangements of multiple flow paths in other arrays is also within the scope of the invention.

### Surface Properties

A surface of the device may include a material, coating, or surface texture that determines the physical properties of the device. In particular, the flow of liquids through a device of the invention may be controlled by the device surface properties (e.g., wettability of a liquid-contacting surface). In some cases, a device portion (e.g., an inlet, channel, or reservoir) may have a surface having a wettability suitable for facilitating liquid flow (e.g., in a channel) or assisting droplet formation (e.g., in a channel), e.g., if droplet formation is performed.

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method. The wettability of each surface may be suited to producing droplets. A device may include a channel having a surface with a first wettability in fluid communication with (e.g., fluidically connected to) another channel or reservoir having a surface with a second wettability. The wettability of each surface may be suited to producing droplets of a first liquid in a second liquid. In this non-limiting example, the channel carrying the first liquid may have a surface with a first wettability suited for the first liquid wetting the channel surface. For example, when the first liquid is substantially miscible with water (e.g., the first liquid is an aqueous liquid), the surface material or coating may have a water contact angle of about 95° or less (e.g., 90° or less). Additionally, in this non-limiting example, other channels may have a surface with a second wettability so that the first liquid de-wets therefrom. For example, when the second liquid is substantially immiscible with water (e.g., the second liquid is an oil), the material or coating used may have a water contact angle of about 70° or more (e.g., 90° or more, 95° or more, or 100° or more). For example, the water contact angles of the materials or coatings employed to produce different wettabilities will differ by 5° to 150°.

For example, portions of the device carrying aqueous phases (e.g., a channel) may have a surface material or coating that is hydrophilic or more hydrophilic than another portion of the device, e.g., include a material or coating having a water contact angle of less than or equal to about 90°, and/or other portions of the device may have a surface material or coating that is hydrophobic or more hydrophobic than the channel, e.g., include a material or coating having a water contact angle of greater than 70° (e.g., greater than 90°, greater than 95°, greater than 100° (e.g., 95°-120° or 100°-150°)). In certain embodiments, a portion of the device may include a material or surface coating that reduces or prevents wetting by aqueous phases. The device can be designed to have a single type of material or coating throughout. Alternatively, the device may have separate regions having different materials or coatings.

In addition or in the alternative, portions of the device carrying or contacting oil phases (e.g., a channel or exterior) may have a surface material or coating that is hydrophobic, fluorophilic, or more hydrophobic or fluorophilic than the portions of the device that contact aqueous phases, e.g., include a material or coating having a water contact angle of greater than or equal to about 90°. Alternatively or in addition, portions of the device containing continuous phase may have a surface material or coating that the continuous phase does not wet, e.g., include a material or coating having a contact angle of greater than 70° (e.g., greater than 90°, greater than 95°, greater than 100°, greater than 110°, (e.g., 95°-180° or 100°-120°)). The device can be designed to have a single type of material or coating throughout. Alternatively, the device may have separate regions having different materials or coatings. Surface textures may also be employed to control fluid flow.

The device surface properties may be those of a native surface (i.e., the surface properties of the bulk material used for the device fabrication) or of a surface treatment. Non-limiting examples of surface treatments include, e.g., surface coatings and surface textures. In one approach, the device surface properties are attributable to one or more surface coatings present in a device portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the device. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be deposited on a surface by contacting it with trimethylaluminum (TMA) and water.

In another approach, the device surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chlorotrifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about 150°).

The difference in water contact angles between that of a hydrophilic or more hydrophilic material or coating and a hydrophobic or more hydrophobic material or coating may be 5° to 150°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, 100°, 110°, 120°, 130°, 140° or 150°.

The above discussion centers on the water contact angle. It will be understood that liquids employed in the devices and methods of the invention may not be water, or even aqueous. Accordingly, the actual contact angle of a liquid on a surface of the device may differ from the water contact angle. Furthermore, the determination of a water contact angle of a material or coating can be made on that material or coating when not incorporated into a device of the invention.

### Particles

The invention includes devices, systems, and kits having particles, e.g., for use in analysis. For example, particles configured with analyte moieties (e.g., barcodes, nucleic acids, binding molecules (e.g., proteins, peptides, aptamers, antibodies, or antibody fragments), enzymes, substrates, etc.) can be included in a droplet containing an analyte to modify the analyte and/or detect the presence or concentration of the analyte. In some embodiments, particles are synthetic particles (e.g., beads, e.g., gel beads).

For example, a droplet may include one or more analyte moieties, e.g., unique identifiers, such as barcodes. Analyte moieties, e.g., barcodes, may be introduced into droplets previous to, subsequent to, or concurrently with droplet formation. The delivery of the analyte moieties, e.g., barcodes, to a particular droplet allows for the later attribution of the characteristics of an individual sample (e.g., biological particle) to the particular droplet. Analyte moieties, e.g., barcodes, may be delivered, for example on a nucleic acid (e.g., an oligonucleotide), to a droplet via any suitable mechanism. Analyte moieties, e.g., barcoded nucleic acids (e.g., oligonucleotides), can be introduced into a droplet via a support, such as a particle, e.g., a bead. In some cases, analyte moieties, e.g., barcoded nucleic acids (e.g., oligonucleotides), can be initially associated with the particle (e.g., bead) and then released upon application of a stimulus which allows the analyte moieties, e.g., nucleic acids (e.g., oligonucleotides), to dissociate or to be released from the particle.

A particle, e.g., a bead, may be porous, non-porous, hollow (e.g., a microcapsule), solid, semi-solid, semi-fluidic, fluidic, and/or a combination thereof. In some instances, a particle, e.g., a bead, may be dissolvable, disruptable, and/or degradable. In some cases, a particle, e.g., a bead, may not be degradable. In some cases, the particle, e.g., a bead, may be a gel bead. A gel bead may be a hydrogel bead. A gel bead may be formed from molecular precursors, such as a polymeric or monomeric species. A semi-solid particle, e.g., a bead, may be a liposomal bead. Solid particles, e.g., beads, may comprise metals including iron oxide, gold, and silver. In some cases, the particle, e.g., the bead, may be a silica bead. In some cases, the particle, e.g., a bead, can be rigid. In other cases, the particle, e.g., a bead, may be flexible and/or compressible.

A particle, e.g., a bead, may comprise natural and/or synthetic materials. For example, a particle, e.g., a bead, can comprise a natural polymer, a synthetic polymer or both natural and synthetic polymers. Examples of natural polymers include proteins and sugars such as deoxyribonucleic acid, rubber, cellulose, starch (e.g., amylose, amylopectin), proteins, enzymes, polysaccharides, silks, polyhydroxyalkanoates, chitosan, dextran, collagen, carrageenan, ispaghula, acacia, agar, gelatin, shellac, sterculia gum, xanthan gum, corn sugar gum, guar gum, gum karaya, agarose, alginic acid, alginate, or natural polymers thereof. Examples of synthetic polymers include acrylics, nylons, silicones, spandex, viscose rayon, polycarboxylic acids, polyvinyl acetate, polyacrylamide, polyacrylate, polyethylene glycol, polyurethanes, polylactic acid, silica, polystyrene, polyacrylonitrile, polybutadiene, polycarbonate, polyethylene, polyethylene terephthalate, poly(chlorotrifluoroethylene), poly(ethylene oxide), poly(ethylene terephthalate), polyethylene, polyisobutylene, poly(methyl methacrylate), poly(oxymethylene), polyformaldehyde, polypropylene, polystyrene, poly(tetrafluoroethylene), poly(vinyl acetate), poly(vinyl alcohol), poly(vinyl chloride), poly(vinylidene dichloride), poly(vinylidene difluoride), poly(vinyl fluoride) and/or combinations (e.g., co-polymers) thereof. Beads may also be formed from materials other than polymers, including lipids, micelles, ceramics, glass-ceramics, material composites, metals, other inorganic materials, and others.

In some instances, the particle, e.g., the bead, may contain molecular precursors (e.g., monomers or polymers), which may form a polymer network via polymerization of the molecular precursors. In some cases, a precursor may be an already polymerized species capable of undergoing further polymerization via, for example, a chemical cross-linkage. In some cases, a precursor can comprise one or more of an acrylamide or a methacrylamide monomer, oligomer, or polymer. In some cases, the particle, e.g., the bead, may comprise prepolymers, which are oligomers capable of further polymerization. For example, polyurethane beads may be prepared using prepolymers. In some cases, the particle, e.g., the bead, may contain individual polymers that may be further polymerized together. In some cases, particles, e.g., beads, may be generated via polymerization of different precursors, such that they comprise mixed polymers, co-polymers, and/or block co-polymers. In some cases, the particle, e.g., the bead, may comprise covalent or ionic bonds between polymeric precursors (e.g., monomers, oligomers, linear polymers), oligonucleotides, primers, and other entities. In some cases, the covalent bonds can be carbon-carbon bonds or thioether bonds.

Cross-linking may be permanent or reversible, depending upon the particular cross-linker used. Reversible cross-linking may allow for the polymer to linearize or dissociate under appropriate conditions. In some cases, reversible cross-linking may also allow for reversible attachment of a material bound to the surface of a bead. In some cases, a cross-linker may form disulfide linkages. In some cases, the chemical cross-linker forming disulfide linkages may be cystamine or a modified cystamine.

Particles, e.g., beads, may be of uniform size or heterogeneous size. In some cases, the diameter of a particle, e.g., a bead, may be at least about 1 micrometer (μm), 5 μm, 10 μm, 20 μm, 30 μm, 40 μm, 50 μm, 60 μm, 70 μm, 80 μm, 90 μm, 100 μm, 250 μm, 500 μm, 1 mm, or greater. In some cases, a particle, e.g., a bead, may have a diameter of less than about 1 μm, 5 μm, 10 μm, 20 μm, 30 μm, 40 μm, 50 μm, 60 μm, 70 μm, 80 μm, 90 μm, 100 μm, 250 μm, 500 μm, 1 mm, or less. In some cases, a particle, e.g., a bead, may have a diameter in the range of about 40-75 μm, 30-75 μm, 20-75 μm, 40-85 μm, 40-95 μm, 20-100 μm, 10-100 μm, 1-100 μm, 20-250 μm, or 20-500 μm. The size of a particle, e.g., a bead, e.g., a gel bead, used to produce droplets is typically on the order of a cross section of a reagent channel and/or sample channel (width or depth). In some cases, the gel beads are larger than the width and/or depth of the sample channel, e.g., at least 1.5×, 2×, 3×, or 4× larger than the width and/or depth of the sample channel.

In certain embodiments, particles, e.g., beads, can be provided as a population or plurality of particles, e.g., beads, having a relatively monodisperse size distribution. Where it may be desirable to provide relatively consistent amounts of reagents within droplets, maintaining relatively consistent particle, e.g., bead, characteristics, such as size, can contribute to the overall consistency. In particular, the particles, e.g., beads, described herein may have size distributions that have a coefficient of variation in their cross-sectional dimensions of less than 50%, less than 40%, less than 30%, less than 20%, and in some cases less than 15%, less than 10%, less than 5%, or less.

Particles may be of any suitable shape. Examples of particles, e.g., beads, shapes include, but are not limited to, spherical, non-spherical, oval, oblong, amorphous, circular, cylindrical, and variations thereof.

A particle, e.g., bead, injected or otherwise introduced into a droplet may comprise releasably, cleavably, or reversibly attached analyte moieties (e.g., barcodes). A particle, e.g., bead, injected or otherwise introduced into a droplet may comprise activatable analyte moieties (e.g., barcodes). A particle, e.g., bead, injected or otherwise introduced into a droplet may be a degradable, disruptable, or dissolvable particle, e.g., a dissolvable bead.

Particles, e.g., beads, within a channel may flow at a substantially regular flow profile (e.g., at a regular flow rate). Such regular flow profiles can permit a droplet, when formed, to include a single particle (e.g., bead) and a single cell, single nucleus, or other biological particle. Such regular flow profiles may permit the droplets to have a dual occupancy (e.g., droplets having at least one bead and at least one cell, nucleus, or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. In some embodiments, the droplets have a 1:1 dual occupancy (i.e., droplets having exactly one particle (e.g., bead) and exactly one cell, one nucleus, or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. Such regular flow profiles and devices that may be used to provide such regular flow profiles are provided, for example, in U.S. Patent Publication No. 2015/0292988, which is entirely incorporated herein by reference.

As discussed above, analyte moieties (e.g., barcodes) can be releasably, cleavably or reversibly attached to the particles, e.g., beads, such that analyte moieties (e.g., barcodes) can be released or be releasable through cleavage of a linkage between the barcode molecule and the particle, e.g., bead, or released through degradation of the particle (e.g., bead) itself, allowing the barcodes to be accessed or be accessible by other reagents, or both. Releasable analyte moieties (e.g., barcodes) may sometimes be referred to as activatable analyte moieties (e.g., activatable barcodes), in that they are available for reaction once released. Thus, for example, an activatable analyte moiety (e.g., activatable barcode) may be activated by releasing the analyte moiety (e.g., barcode) from a particle, e.g., bead (or other suitable type of droplet described herein). Other activatable configurations are also envisioned in the context of the described methods and systems.

In addition to, or as an alternative to the cleavable linkages between the particles, e.g., beads, and the associated moieties, such as barcode containing nucleic acids (e.g., oligonucleotides), the particles, e.g., beads, may be degradable, disruptable, or dissolvable spontaneously or upon exposure to one or more stimuli (e.g., temperature changes, pH changes, exposure to particular chemical species or phase, exposure to light, reducing agent, etc.). In some cases, a particle, e.g., bead, may be dissolvable, such that material components of the particle, e.g., bead, are degraded or solubilized when exposed to a particular chemical species or an environmental change, such as a change temperature or a change in pH. In some cases, a gel bead can be degraded or dissolved at elevated temperature and/or in basic conditions. In some cases, a particle, e.g., bead, may be thermally degradable such that when the particle, e.g., bead, is exposed to an appropriate change in temperature (e.g., heat), the particle, e.g., bead, degrades. Degradation or dissolution of a particle (e.g., bead) bound to a species (e.g., a nucleic acid, e.g., an oligonucleotide, e.g., barcoded oligonucleotide) may result in release of the species from the particle, e.g., bead. As will be appreciated from the above disclosure, the degradation of a particle, e.g., bead, may refer to the disassociation of a bound or entrained species from a particle, e.g., bead, both with and without structurally degrading the physical particle, e.g., bead, itself. For example, entrained species may be released from particles, e.g., beads, through osmotic pressure differences due to, for example, changing chemical environments. By way of example, alteration of particle, e.g., bead, pore sizes due to osmotic pressure differences can generally occur without structural degradation of the particle, e.g., bead, itself. In some cases, an increase in pore size due to osmotic swelling of a particle (e.g., a bead or a liposome), can permit the release of entrained species within the particle. In other cases, osmotic shrinking of a particle may cause the particle, e.g., bead, to better retain an entrained species due to pore size contraction.

A degradable particle, e.g., bead, may be introduced into a droplet, such that the particle, e.g., bead, degrades within the droplet and any associated species (e.g., nucleic acids, oligonucleotides, or fragments thereof) are released within the droplet when the appropriate stimulus is applied. The free species (e.g., nucleic acid, oligonucleotide, or fragment thereof) may interact with other reagents contained in the droplet. For example, a polyacrylamide bead comprising cystamine and linked, via a disulfide bond, to a barcode sequence, may be combined with a reducing agent within a droplet of a water-in-oil emulsion. Within the droplet, the reducing agent can break the various disulfide bonds, resulting in particle, e.g., bead, degradation and release of the barcode sequence into the aqueous, inner environment of the droplet. In another example, heating of a droplet comprising a particle-, e.g., bead-, bound analyte moiety (e.g., barcode) in basic solution may also result in particle, e.g., bead, degradation and release of the attached barcode sequence into the aqueous, inner environment of the droplet.

Any suitable number of analyte moieties (e.g., molecular tag molecules (e.g., primer, barcoded oligonucleotide, etc.)) can be associated with a particle, e.g., bead, such that, upon release from the particle, the analyte moieties (e.g., molecular tag molecules (e.g., primer, e.g., barcoded oligonucleotide, etc.)) are present in the droplet at a pre-defined concentration. Such pre-defined concentration may be selected to facilitate certain reactions for generating a sequencing library, e.g., amplification, within the droplet. In some cases, the pre-defined concentration of a primer can be limited by the process of producing oligonucleotide-bearing particles, e.g., beads.

Additional reagents may be included as part of the particles (e.g., analyte moieties) and/or in solution or dispersed in the droplet, for example, to activate, mediate, or otherwise participate in a reaction, e.g., between the analyte and analyte moiety.

### Biological Samples

A droplet of the invention may include biological particles (e.g., cells, nuclei, or particulate components thereof, e.g., organelles, such as a nucleus or a mitochondrion) and/or macromolecular constituents thereof (e.g., components of cells/nuclei (e.g., intracellular or extracellular proteins, nucleic acids, glycans, or lipids) or products of cells (e.g., secretion products)). An analyte from a biological particle, e.g., component or product thereof, may be considered to be a bioanalyte. In some embodiments, a biological particle, e.g., cell, nucleus, or product thereof is included in a droplet, e.g., with one or more particles (e.g., beads) having an analyte moiety. A biological particle, e.g., cell, nucleus, and/or components or products thereof can, in some embodiments, be encased inside a gel, such as via polymerization of a droplet containing the biological particle and precursors capable of being polymerized or gelled.

Biological samples may also be processed to provide cell beads for use with methods and systems described herein. A cell bead can be a biological particle and/or one or more of its macromolecular constituents encased inside of a gel or polymer matrix, such as via polymerization of a droplet containing the biological particle and precursors capable of being polymerized or gelled. Polymeric precursors (as described herein) may be subjected to conditions sufficient to polymerize or gel the precursors thereby forming a polymer or gel around the biological particle. A cell bead can contain biological particles (e.g., a cell or an organelle of a cell) or macromolecular constituents (e.g., RNA, DNA, proteins, etc.) of biological particles. A cell bead may include a single biological particle or multiple biological particles, or a derivative of the biological particle or biological particle. For example, after lysing and washing the cells, inhibitory components from cell lysates can be washed away and the macromolecular constituents can be bound as cell beads. Systems and methods disclosed herein can be applicable to both cell beads (and/or droplets or other partitions) containing biological particles and cell beads (and/or droplets or other partitions) containing macromolecular constituents of biological particles. Cell beads may be or include a cell, nucleus, cell derivative, cellular material and/or material derived from the cell in, within, or encased in a matrix, such as a polymeric matrix. In some cases, a cell bead may comprise a live cell. In some instances, the live cell may be capable of being cultured when enclosed in a gel or polymer matrix, or of being cultured when comprising a gel or polymer matrix. In some instances, the polymer or gel may be diffusively permeable to certain components and diffusively impermeable to other components (e.g., macromolecular constituents). It will be appreciated that other techniques for generating and utilizing cell beads can be used with the present invention, see, e.g., U.S. Pat. Nos. 10,590,244 and 10,428,326, as well as U.S. Pat. Pub. Nos. 2019/0233878, each of which is hereby incorporated by reference in its entirety.

In the case of encapsulated biological particles (e.g., cells, nuclei, or particulate components thereof), a biological particle may be included in a droplet that contains lysis reagents in order to release the contents (e.g., contents containing one or more analytes (e.g., bioanalytes)) of the biological particles within the droplet. In such cases, the lysis agents can be contacted with the biological particle suspension concurrently with, or immediately prior to the introduction of the biological particles into the intersection. Examples of lysis agents include bioactive reagents, such as lysis enzymes that are used for lysis of different cell types, e.g., gram positive or negative bacteria, plants, yeast, mammalian, etc., such as lysozymes, achromopeptidase, lysostaphin, labiase, kitalase, lyticase, and a variety of other lysis enzymes available from, e.g., Sigma-Aldrich, Inc. (St Louis, Mo.), as well as other commercially available lysis enzymes. Other lysis agents may additionally or alternatively be contained in a droplet with the biological particles (e.g., cells, nuclei, or particulate components thereof) to cause the release of the biological particles' contents into the droplets. For example, in some cases, surfactant-based lysis solutions may be used to lyse cells, although these may be less desirable for emulsion based systems where the surfactants can interfere with stable emulsions. In some cases, lysis solutions may include non-ionic surfactants such as, for example, TritonX-100 and Tween 20. In some cases, lysis solutions may include ionic surfactants such as, for example, sarcosyl and sodium dodecyl sulfate (SDS). In some embodiments, lysis solutions are hypotonic, thereby lysing cells by osmotic shock. Electroporation, thermal, acoustic or mechanical cellular disruption may also be used in certain cases, e.g., non-emulsion based droplet formation such as encapsulation of biological particles that may be in addition to or in place of droplet formation, where any pore size of the encapsulate is sufficiently small to retain nucleic acid fragments of a desired size, following cellular disruption.

In addition to the lysis agents, other reagents can also be included in droplets with the biological particles, including, for example, DNase and RNase inactivating agents or inhibitors, such as proteinase K, chelating agents, such as EDTA, and other reagents employed in removing or otherwise reducing negative activity or impact of different cell lysate components on subsequent processing of nucleic acids. In addition, in the case of encapsulated biological particles (e.g., cells, nuclei, or particulate components thereof), the biological particles may be exposed to an appropriate stimulus to release the biological particles or their contents from a particle (e.g., a bead or a microcapsule) within a droplet. For example, in some cases, a chemical stimulus may be included in a droplet along with an encapsulated biological particle to allow for degradation of the encapsulating matrix and release of the cell/nucleus or its contents into the larger droplet. In some cases, this stimulus may be the same as the stimulus described elsewhere herein for release of analyte moieties (e.g., oligonucleotides) from their respective particle (e.g., bead). In alternative aspects, this may be a different and non-overlapping stimulus, in order to allow an encapsulated biological particle to be released into a droplet at a different time from the release of analyte moieties (e.g., oligonucleotides) into the same droplet.

Additional reagents may also be included in droplets with the biological particles, such as endonucleases to fragment a biological particle's DNA, DNA polymerase enzymes and dNTPs used to amplify the biological particle's nucleic acid fragments and to attach the barcode molecular tags to the amplified fragments. Other reagents may also include reverse transcriptase enzymes, including enzymes with terminal transferase activity, primers and oligonucleotides, and switch oligonucleotides (also referred to herein as “switch oligos” or “template switching oligonucleotides”) which can be used for template switching. In some cases, template switching can be used to increase the length of a cDNA. In some cases, template switching can be used to append a predefined nucleic acid sequence to the cDNA. In an example of template switching, cDNA can be generated from reverse transcription of a template, e.g., cellular mRNA, where a reverse transcriptase with terminal transferase activity can add additional nucleotides, e.g., polyC, to the cDNA in a template independent manner. Switch oligos can include sequences complementary to the additional nucleotides, e.g., polyG. The additional nucleotides (e.g., polyC) on the cDNA can hybridize to the additional nucleotides (e.g., polyG) on the switch oligo, whereby the switch oligo can be used by the reverse transcriptase as template to further extend the cDNA. Template switching oligonucleotides may comprise a hybridization region and a template region. The hybridization region can comprise any sequence capable of hybridizing to the target. In some cases, as previously described, the hybridization region comprises a series of G bases to complement the overhanging C bases at the 3′ end of a cDNA molecule. The series of G bases may comprise 1 G base, 2 G bases, 3 G bases, 4 G bases, 5 G bases or more than 5 G bases. The template sequence can comprise any sequence to be incorporated into the cDNA. In some cases, the template region comprises at least 1 (e.g., at least 2, 3, 4, 5 or more) tag sequences and/or functional sequences. Switch oligos may comprise deoxyribonucleic acids; ribonucleic acids; modified nucleic acids including 2-Aminopurine, 2,6-Diaminopurine (2-Amino-dA), inverted dT, 5-Methyl dC, 2′-deoxyinosine, Super T (5-hydroxybutynl-2′-deoxyuridine), Super G (8-aza-7-deazaguanosine), locked nucleic acids (LNAs), unlocked nucleic acids (UNAs, e.g., UNA-A, UNA-U, UNA-C, UNA-G), Iso-dG, Iso-dC, 2′ Fluoro bases (e.g., Fluoro C, Fluoro U, Fluoro A, and Fluoro G), or any combination.

In some cases, the length of a switch oligo may be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250 nucleotides or longer.

In some cases, the length of a switch oligo may be at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides or longer.

In some cases, the length of a switch oligo may be at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides.

Once the contents of the cells or nuclei are released into their respective droplets, the macromolecular components (e.g., macromolecular constituents of biological particles, such as RNA, DNA, or proteins) contained therein may be further processed within the droplets.

As described above, the macromolecular components (e.g., bioanalytes) of individual biological particles (e.g., cells, nuclei, or particulate components thereof) can be provided with unique identifiers (e.g., barcodes) such that upon characterization of those macromolecular components, at which point components from a heterogeneous population of cells/nuclei may have been mixed and are interspersed or solubilized in a common liquid, any given component (e.g., bioanalyte) may be traced to the biological particle (e.g., cell or nucleus) from which it was obtained. The ability to attribute characteristics to individual biological particles or groups of biological particles is provided by the assignment of unique identifiers specifically to an individual biological particle or groups of biological particles. Unique identifiers, for example, in the form of nucleic acid barcodes, can be assigned or associated with individual biological particles (e.g., cells, nuclei, or particulate components thereof) or populations of biological particles (e.g., cells, nuclei, or particulate components thereof), in order to tag or label the biological particle's macromolecular components (and as a result, its characteristics) with the unique identifiers. These unique identifiers can then be used to attribute the biological particle's components and characteristics to an individual biological particle or group of biological particles. This can be performed by forming droplets including the individual biological particle or groups of biological particles with the unique identifiers (via particles, e.g., beads), as described in the systems and methods herein.

In some aspects, the unique identifiers are provided in the form of oligonucleotides that comprise nucleic acid barcode sequences that may be attached to or otherwise associated with the nucleic acid contents of individual biological particle, or to other components of the biological particle, and particularly to fragments of those nucleic acids. The oligonucleotides are partitioned such that as between oligonucleotides in a given droplet, the nucleic acid barcode sequences contained therein are the same, but as between different droplets, the oligonucleotides can, and do have differing barcode sequences, or at least represent a large number of different barcode sequences across all of the droplets in a given analysis. In some aspects, only one nucleic acid barcode sequence can be associated with a given droplet, although in some cases, two or more different barcode sequences may be present.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Analyte moieties (e.g., oligonucleotides) in droplets can also include other functional sequences useful in processing of nucleic acids from biological particles contained in the droplet. These sequences include, for example, targeted or random/universal amplification primer sequences for amplifying the genomic DNA from the individual biological particles within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

Other mechanisms of forming droplets containing oligonucleotides may also be employed, including, e.g., coalescence of two or more droplets, where one droplet contains oligonucleotides, or microdispensing of oligonucleotides into droplets, e.g., droplets within microfluidic systems.

In an example, particles (e.g., beads) are provided that each include large numbers of the above described barcoded oligonucleotides releasably attached to the beads, where all of the oligonucleotides attached to a particular bead will include the same nucleic acid barcode sequence, but where a large number of diverse barcode sequences are represented across the population of beads used. In some embodiments, hydrogel beads, e.g., beads having polyacrylamide polymer matrices, are used as a solid support and delivery vehicle for the oligonucleotides into the droplets, as they are capable of carrying large numbers of oligonucleotide molecules, and may be configured to release those oligonucleotides upon exposure to a particular stimulus, as described elsewhere herein. In some cases, the population of beads will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more. Additionally, each bead can be provided with large numbers of oligonucleotide molecules attached. In particular, the number of molecules of oligonucleotides including the barcode sequence on an individual bead can be at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules, or more.

Moreover, when the population of beads are included in droplets, the resulting population of droplets can also include a diverse barcode library that includes at least about 1,000 different barcode sequences, at least about 5,000 different barcode sequences, at least about 10,000 different barcode sequences, at least at least about 50,000 different barcode sequences, at least about 100,000 different barcode sequences, at least about 1,000,000 different barcode sequences, at least about 5,000,000 different barcode sequences, or at least about 10,000,000 different barcode sequences. Additionally, each droplet of the population can include at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules.

In some cases, it may be desirable to incorporate multiple different barcodes within a given droplet, either attached to a single or multiple particles, e.g., beads, within the droplet. For example, in some cases, mixed, but known barcode sequences set may provide greater assurance of identification in the subsequent processing, for example, by providing a stronger address or attribution of the barcodes to a given droplet, as a duplicate or independent confirmation of the output from a given droplet.

Oligonucleotides may be releasable from the particles (e.g., beads) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature of the particle, e.g., bead, environment will result in cleavage of a linkage or other release of the oligonucleotides form the particles, e.g., beads. In still other cases, a chemical stimulus is used that cleaves a linkage of the oligonucleotides to the beads, or otherwise results in release of the oligonucleotides from the particles, e.g., beads. In one case, such compositions include the polyacrylamide matrices described above for encapsulation of biological particles and may be degraded for release of the attached oligonucleotides through exposure to a reducing agent, such as dithiothreitol (DTT).

The droplets described herein may contain either one or more biological particles (e.g., cells, nuclei, or particulate components thereof), either one or more barcode carrying particles, e.g., beads, or both at least a biological particle and at least a barcode carrying particle, e.g., bead. In some instances, a droplet may be unoccupied and contain neither biological particles nor barcode-carrying particles, e.g., beads. As noted previously, by controlling the flow characteristics of each of the liquids combining at the intersection(s), as well as controlling the geometry of the intersection(s), droplet formation can be optimized to achieve a desired occupancy level of particles, e.g., beads, biological particles, or both, within the droplets that are generated.

### Kits and Systems

Devices of the invention may be combined with various external components, e.g., pumps, reservoirs, or controllers, reagents, e.g., analyte moieties, liquids, particles (e.g., beads), and/or sample in the form of kits and systems.

### Methods

The methods described herein to generate droplets, e.g., of uniform and predictable content, and with high throughput, may be used to greatly increase the efficiency of single cell/nuclei applications and/or other applications receiving droplet-based input. Such single cell/nuclei applications and other applications may often be capable of processing a certain range of droplet sizes. The methods may be employed to generate droplets for use as microscale chemical reactors, where the volumes of the chemical reactants are small (˜pLs).

Methods of the invention include allowing one or more reagent fluids to flow from the one or more reagent inlets via the one or more reagent channels, one or more sample fluids from the one or more sample inlets via the one or more sample channels (e.g., the first and second sample channels) and one or more oils from the one or more oil inlets via one or more oil channels (e.g., the first, second, third, and fourth oil channels) to where the one or more reagent fluids and one or more sample fluids combine independently at a first and second intersection and flow through a droplet channel to an intersection with two oil channels where droplets of the combined reagent and sample fluids form in the oil before collecting the droplets in one or more collection reservoirs.

A variety of applications require the evaluation of the presence and quantification of different biological particle or organism types within a population of biological particles, including, for example, microbiome analysis and characterization, environmental testing, food safety testing, epidemiological analysis, e.g., in tracing contamination or the like.

The methods described herein may allow for the production of one or more droplets containing a single particle, e.g., bead, and/or single biological particle (e.g., cell, nucleus, or particulate component thereof) with uniform and predictable droplet content. The methods described herein may allow for the production of one or more droplets containing a single particle, e.g., bead, and/or single biological particle (e.g., cell, nucleus, or particulate component thereof) with uniform and predictable droplet size. The methods may also allow for the production of one or more droplets comprising a single biological particle (e.g., cell, nucleus, or particulate component thereof) and more than one particle, e.g., bead, one or more droplets comprising more than one biological particle (e.g., cell, nucleus, or particulate components thereof) and a single particle, e.g., bead, and/or one or more droplets comprising more than one biological particle (e.g., cell, nucleus, or particulate components thereof) and more than one particle, e.g., beads. The methods may also allow for increased throughput of droplet formation.

Mixers can be used to mix two fluid streams, e.g., before the droplet formation. Mixing two fluids is advantageous for controlling content uniformity of fluid streams and of droplets formed from such fluid streams. For example, one fluid (e.g., a sample fluid) and another fluid (e.g., a reagent fluid) may be combined at an intersection of two channels (e.g., an intersection of a sample channel and a reagent channel). One fluid may contain a biological particle (e.g., a cell, nucleus, or particulate components thereof), and the other fluid may contain reagents. By using a mixer, the two fluids can be rapidly mixed, thereby reducing localized high concentrations of lysing reagents. Thus, biological particle lysis may be reduced or eliminated until the droplet formation.

In methods described herein, funnels (e.g., rectifiers) may be used to control particle (e.g., bead) flow, e.g., to provide evenly spaced particles (e.g., beads). The evenly spaced particles may be used for forming droplets containing a single particle.

The droplets may comprise an aqueous liquid dispersed phase within a non-aqueous continuous phase, such as an oil phase. Emulsion systems for creating stable droplets in non-aqueous (e.g., oil) continuous phases are described in detail in, for example, U.S. Pat. No. 9,012,390, which is entirely incorporated herein by reference for all purposes. Alternatively or in addition, the droplets may comprise, for example, micro-vesicles that have an outer barrier surrounding an inner liquid center or core. In some cases, the droplets may comprise a porous matrix that is capable of entraining and/or retaining materials within its matrix. A variety of different vessels are described in, for example, U.S. Patent Application Publication No. 2014/0155295, which is entirely incorporated herein by reference for all purposes. The droplets can be collected in a substantially stationary volume of liquid, e.g., with the buoyancy of the formed droplets moving them out of the path of nascent droplets (up or down depending on the relative density of the droplets and continuous phase). Alternatively or in addition, the formed droplets can be moved out of the path of nascent droplets actively, e.g., using a gentle flow of the continuous phase, e.g., a liquid stream or gently stirred liquid.

Allocating supports, e.g., particles (e.g., beads carrying barcoded oligonucleotides) or biological particles (e.g., cells, nuclei, or particulate components thereof) to discrete droplets may generally be accomplished by introducing a flowing stream of particles, e.g., beads, in an aqueous liquid into a flowing stream or non-flowing reservoir of a non-aqueous liquid, such that droplets are generated. In some instances, the occupancy of the resulting droplets (e.g., number of particles, e.g., beads, per droplet) can be controlled by providing the aqueous stream at a certain concentration or frequency of particles, e.g., beads. In some instances, the occupancy of the resulting droplets can also be controlled by adjusting one or more geometric features at the intersection, such as a width of a fluidic channel carrying the particles, e.g., beads, relative to a diameter of a given particles, e.g., beads.

Where single particle-, e.g., bead-, containing droplets are desired, the relative flow rates of the liquids can be selected such that, on average, the droplets contain fewer than one particle, e.g., bead, per droplet in order to ensure that those droplets that are occupied are primarily singly occupied. In some embodiments, the relative flow rates of the liquids can be selected such that a majority of droplets are occupied, for example, allowing for only a small percentage of unoccupied droplets. The flows and channel architectures can be controlled as to ensure a desired number of singly occupied droplets, less than a certain level of unoccupied droplets and/or less than a certain level of multiply occupied droplets.

The methods described herein can be operated such that a majority of occupied droplets include no more than one biological particle per occupied droplet. In some cases, the droplet formation process is conducted such that fewer than 25% of the occupied droplets contain more than one biological particle (e.g., multiply occupied droplets), and in many cases, fewer than 20% of the occupied droplets have more than one biological particle. In some cases, fewer than 10% or even fewer than 5% of the occupied droplets include more than one biological particle per droplet.

The flow of the one or more fluids may be such that the droplets contain a single particle, e.g., bead. In certain embodiments, the yield of droplets containing a single particle is at least 80%, e.g., at least 85%, at least 86%, at least 87%, at least 88%, at least 89%, at least 90%, at least 91%, at least 92%, at least 93%, at least 94%, at least 95%, at least 96%, at least 97%, at least 98%, or at least 99%.

As will be appreciated, the above-described occupancy rates are also applicable to droplets that include both biological particles (e.g., cells, nucleus, or particulate components thereof, or incorporated into cell beads) and beads (e.g., gel beads). The occupied droplets (e.g., at least about 10%, 20%, 30%, 40%, 50%, 60%, 70%, 80%, 90%, 95%, or 99% of the occupied droplets) can include both a bead and a biological particle. Particles, e.g., beads, within a channel (e.g., a reagent channel) may flow at a substantially regular flow profile (e.g., at a regular flow rate; e.g., the flow profile being controlled by one or more funnels) to provide a droplet, when formed, with a single particle (e.g., bead) and a single cell/nucleus or other biological particle (e.g., within a cell bead). Such regular flow profiles may permit the droplets to have a dual occupancy (e.g., droplets having at least one bead and at least one biological particle (e.g., cell or nucleus), e.g., within a cell bead) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. In some embodiments, the droplets have a 1:1 dual occupancy (i.e., droplets having exactly one particle (e.g., bead) and exactly one biological particle (e.g., cell or nucleus), e.g., within a cell bead) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. Such regular flow profiles and devices that may be used to provide such regular flow profiles are provided, for example, in U.S. Patent Publication No. 2015/0292988, which is entirely incorporated herein by reference.

In some cases, additional particles may be used to deliver additional reagents to a droplet. In such cases, it may be advantageous to introduce different particles (e.g., beads) into a common channel (e.g., proximal to or upstream from an intersection) from different bead sources (e.g., containing different associated reagents) through different channel inlets into such common channel. In such cases, the flow and/or frequency of each of the different particle, e.g., bead, sources into the channel or fluidic connections may be controlled to provide for the desired ratio of particles, e.g., beads, from each source, while optionally ensuring the desired pairing or combination of such particles, e.g., beads, are formed into a droplet with the desired number of biological particles.

The droplets described herein may comprise small volumes, for example, less than about 10 microliters (μL), 5 μL, 1 μL, 900 picoliters (pL), 800 pL, 700 pL, 600 pL, 500 pL, 400 pL, 300 pL, 200 pL, 100 pL, 50 pL, 20 pL, 10 pL, 1 pL, 500 nanoliters (nL), 100 nL, 50 nL, or less. For example, the droplets may have overall volumes that are less than about 1000 pL, 900 pL, 800 pL, 700 pL, 600 pL, 500 pL, 400 pL, 300 pL, 200 pL, 100 pL, 50 pL, 20 pL, 10 pL, 1 pL, or less. Where the droplets further comprise supports (e.g., particles, such as beads), it will be appreciated that the sample liquid volume within the droplets may be less than about 90% of the above described volumes, less than about 80%, less than about 70%, less than about 60%, less than about 50%, less than about 40%, less than about 30%, less than about 20%, or less than about 10% the above described volumes (e.g., of a partitioning liquid), e.g., from 1% to 99%, from 5% to 95%, from 10% to 90%, from 20% to 80%, from 30% to 70%, or from 40% to 60%, e.g., from 1% to 5%, 5% to 10%, 10% to 15%, 15% to 20%, 20% to 25%, 25% to 30%, 30% to 35%, 35% to 40%, 40% to 45%, 45% to 50%, 50% to 55%, 55% to 60%, 60% to 65%, 65% to 70%, 70% to 75%, 75% to 80%, 80% to 85%, 85% to 90%, 90% to 95%, or 95% to 100% of the above described volumes.

Any suitable number of droplets can be generated. For example, in a method described herein, a plurality of droplets may be generated that comprises at least about 1,000 droplets, at least about 5,000 droplets, at least about 10,000 droplets, at least about 50,000 droplets, at least about 100,000 droplets, at least about 500,000 droplets, at least about 1,000,000 droplets, at least about 5,000,000 droplets at least about 10,000,000 droplets, at least about 50,000,000 droplets, at least about 100,000,000 droplets, at least about 500,000,000 droplets, at least about 1,000,000,000 droplets, or more. Moreover, the plurality of droplets may comprise both unoccupied droplets (e.g., empty droplets) and occupied droplets.

The fluid to be dispersed into droplets may be transported from one or more inlets to the droplet channel and intersection. Alternatively, the one or more fluids to be dispersed into droplets is formed in situ by combining two or more fluids in the device. For example, the fluid to be dispersed may be formed by combining one fluid containing one or more reagents with one or more other fluids containing one or more reagents. In these embodiments, the mixing of the fluid streams may result in a chemical reaction. For example, when a particle is employed, a fluid having reagents that disintegrates the particle may be combined with the particle, e.g., immediately upstream of the intersection of the droplet channel and oil channels. In these embodiments, the particles may be cells or nuclei, which can be combined with lysing reagents, such as surfactants. When particles, e.g., beads, are employed, the particles, e.g., beads, may be dissolved or chemically degraded, e.g., by a change in pH (acid or base), redox potential (e.g., addition of an oxidizing or reducing agent), enzymatic activity, change in salt or ion concentration, or other mechanism.

The combined fluids are transported through the droplet channel at a flow rate sufficient to produce droplets in the oil at the intersection. Faster flow rates of the combined fluids generally increase the rate of droplet production; however, at a high enough rate, the fluid will form a jet, which may not break up into droplets. Typically, the flow rate of the combined fluids though the channel may be between about 0.01 μL/min to about 100 μL/min, e.g., 0.1 to 50 μL/min, 0.1 to 10 μL/min, or 1 to 5 μL/min. In some instances, the flow rate of the combined fluids may be between about 0.04 μL/min and about 40 μL/min. In some instances, the flow rate of the combined fluids may be between about 0.01 μL/min and about 100 μL/min. Alternatively, the flow rate of the combined fluids may be less than about 0.01 μL/min. Alternatively, the flow rate of the combined fluids may be greater than about 40 μL/min, e.g., 45 μL/min, 50 μL/min, 55 μL/min, 60 μL/min, 65 μL/min, 70 μL/min, 75 μL/min, 80 μL/min, 85 μL/min, 90 μL/min, 95 μL/min, 100 μL/min, 110 μL/min, 120 μL/min, 130 μL/min, 140 μL/min, 150 μL/min, or greater. At lower flow rates, such as flow rates of about less than or equal to 10 μL/min, the droplet radius may not be dependent on the flow rate of first liquid. Alternatively, or in addition, for any of the abovementioned flow rates, the droplet radius may be independent of the flow rate of the combined fluids.

The Reynolds number (Re) for fluids flowing though the channels may be from about 0.01 to about 100, e.g., 0.1 to 50, 0.1 to 10, or 1 to 5. In some instances, the Re may be from about 1 to about 10, e.g., about 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, or 9.9.

The typical droplet formation rate for a single channel in a device of the invention is between 0.1 Hz to 10,000 Hz, e.g., 1 to 1000 Hz or 1 to 500 Hz. The use of multiple droplet channels can increase the rate of droplet formation by increasing the number of locations of formation.

The methods may be used to produce droplets in range of 1 μm to 500 μm in diameter, e.g., 1 to 250 μm, 5 to 200 μm, 5 to 150 μm, or 12 to 125 μm.

The dispersed liquid may be aqueous, and the continuous phase may be an oil (or vice versa). Examples of oils include perfluorinated oils, mineral oil, and silicone oils. For example, a fluorinated oil may include a fluorosurfactant for stabilizing the resulting droplets, for example, inhibiting subsequent coalescence of the resulting droplets. Examples of particularly useful liquids and fluorosurfactants are described, for example, in U.S. Pat. No. 9,012,390, which is entirely incorporated herein by reference for all purposes. Specific examples include hydrofluoroethers, such as HFE 7500, 7300, 7200, or 7100. Suitable liquids are those described in US 2015/0224466 and U.S. 62/522,292, the liquids of which are hereby incorporated by reference. In some cases, liquids include additional components such as a particle, e.g., a cell (or nucleus) or a gel bead. As discussed above, fluids may include reagents for carrying out various reactions, such as nucleic acid amplification, lysis, or bead dissolution. The dispersed liquid or continuous phase may include additional components that stabilize or otherwise affect the droplets or a component inside the droplet. Such additional components include surfactants, antioxidants, preservatives, buffering agents, antibiotic agents, salts, chaotropic agents, enzymes, nanoparticles, and sugars.

Once formed, droplets may be manipulated, e.g., transported, detected, sorted, held, incubated, reacted, or demulsified.

Devices, systems, compositions, and methods of the invention may be used for various applications, such as, for example, processing a single analyte (e.g., bioanalytes, e.g., RNA, DNA, or protein) or multiple analytes (e.g., bioanalytes, e.g., DNA and RNA, DNA and protein, RNA and protein, or RNA, DNA and protein) from a single cell or single nucleus. For example, a biological particle (e.g., a cell, a nucleus, or virus) can be formed in a droplet, and one or more analytes (e.g., bioanalytes) from the biological particle (e.g., cell or nucleus) can be modified or detected (e.g., bound, labeled, or otherwise modified by an analyte moiety) for subsequent processing. The multiple analytes may be from the single cell or nucleus. This process may enable, for example, proteomic, transcriptomic, and/or genomic analysis of the cell (or nucleus) or population thereof (e.g., simultaneous proteomic, transcriptomic, and/or genomic analysis of the cell (or nucleus) or population thereof).

Methods of the invention may include adding a sample and/or particles to the device, for example, (a) by pipetting a sample liquid, or a component or concentrate thereof, into a sample reservoir (e.g., a sample inlet) and/or (b) by pipetting a liquid carrier (e.g., an aqueous carrier) and/or particles into a particle reservoir (e.g., a sample inlet). In some embodiments, the method involves first adding (e.g., pipetting) the liquid carrier (e.g., an aqueous carrier) and/or particles into the particle reservoir prior to adding (e.g., pipetting) the sample liquid, or a component or concentrate thereof, into the sample reservoir. In some embodiments, the liquid carrier added to the particle reservoir includes lysing reagents.

The sample reservoir and/or particle reservoir may be incubated in conditions suitable to preserve or promote activity of their contents until the initiation or commencement of droplet formation.

Also provided herein are methods of single-cell/nucleus nucleic acid sequencing, in which a heterologous population of cells/nuclei can be characterized by their individual gene expression, e.g., relative to other cells/nuclei of the population. Methods of barcoding cells or nuclei discussed herein and known in the art can be part of the methods of single-cell/nucleus nucleic acid sequencing provided herein. After barcoding, nucleic acid transcripts that have been barcoded are sequenced, and sequences can be processed, analyzed, and stored according to known methods. In some embodiments, these methods enable the generation of a genome library containing gene expression data for any single cell/single nucleus within a heterologous population.

Alternatively, the ability to sequester a single cell, single nucleus, or particulate component thereof in a droplet provided by methods herein enables applications beyond genome characterization. For example, a droplet containing a single cell, single nucleus, or particulate component thereof can allow a single cell/nucleus to be detectably labeled to provide relative protein expression data. Binding of antibodies to proteins can occur within the reaction droplet, and cells/nuclei can be subsequently analyzed for bound antibodies according to known methods to generate a library of protein expression. Other methods known in the art can be employed to characterize cells within heterologous populations. In one example, following the formation or droplets, subsequent operations that can be performed can include formation of amplification products, purification (e.g., via solid phase reversible immobilization (SPRI)), further processing (e.g., shearing, ligation of functional sequences, and subsequent amplification (e.g., via PCR)). These operations may occur in bulk (e.g., outside the droplet). An exemplary use for droplets formed using methods of the invention is in performing nucleic acid amplification, e.g., polymerase chain reaction (PCR), where the reagents necessary to carry out the amplification are contained within the first fluid. In the case where a droplet is a droplet in an emulsion, the emulsion can be broken and the contents of the droplet pooled for additional operations. Additional reagents that may be included in a droplet along with the barcode bearing bead may include oligonucleotides to block ribosomal RNA (rRNA) and nucleases to digest genomic DNA from cells. Alternatively, rRNA removal agents may be applied during additional processing operations. The configuration of the constructs generated by such a method can help minimize (or avoid) sequencing of poly-T sequence during sequencing and/or sequence the 5′ end of a polynucleotide sequence. The amplification products, for example first amplification products and/or second amplification products, may be subject to sequencing for sequence analysis. In some cases, amplification may be performed using the Partial Hairpin Amplification for Sequencing (PHASE) method.

### Methods of Device Manufacture

The microfluidic devices of the invention may be fabricated in any of a variety of conventional ways. For example, in some cases the devices comprise layered structures, where a first layer includes a planar surface into which is disposed a series of channels or grooves that correspond to the channel network in the finished device. A second layer includes a planar surface on one side, and a series of reservoirs defined on the opposing surface, where the reservoirs communicate as passages through to the planar layer, such that when the planar surface of the second layer is mated with the planar surface of the first layer, the reservoirs defined in the second layer are positioned in liquid communication with the termini of the channels on the first layer. Alternatively, both the reservoirs and the connected channels may be fabricated into a single part, where the reservoirs are provided upon a first surface of the structure, with the apertures of the reservoirs extending through to the opposing surface of the structure. The channel network is fabricated as a series of grooves and features in this second surface. A thin laminating layer is then provided over the second surface to seal, and provide the final wall of the channel network, and the bottom surface of the reservoirs.

These layered structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof. Polymeric device components may be fabricated using any of a number of processes including soft lithography, embossing techniques, micromachining, e.g., laser machining, or in some aspects injection molding of the layer components that include the defined channels as well as other structures, e.g., reservoirs, integrated functional components, etc. In some aspects, the structure comprising the reservoirs and channels may be fabricated using, e.g., injection molding techniques to produce polymeric structures. In such cases, a laminating layer may be adhered to the molded structured part through readily available methods, including thermal lamination, solvent based lamination, sonic welding, or the like.

As will be appreciated, structures comprised of inorganic materials also may be fabricated using known techniques. For example, channels and other structures may be micro-machined into surfaces or etched into the surfaces using standard photolithographic techniques. In some aspects, the microfluidic devices or components thereof may be fabricated using three-dimensional printing techniques to fabricate the channel or other structures of the devices and/or their discrete components.

### Methods for Surface Modifications

The invention features methods for producing a microfluidic device that has a surface modification, e.g., a surface with a modified water contact angle. The methods may be employed to modify the surface of a device such that a liquid can “wet” the surface by altering the contact angle the liquid makes with the surface. An exemplary use of the methods of the invention is in creating a device having differentially coated surfaces to optimize droplet formation.

Devices to be modified with surface coating agents may be primed, e.g., pre-treated, before coating processes occur. A surface of the microfluidic device is contacted by at least one reagent that has an affinity for the primed surface to produce a surface having a first water contact angle of greater than about 90°, e.g., a hydrophobic or fluorophilic surface. In certain embodiments, the first contact angle is greater than the water contact angle of the primed surface. In other embodiments, the first contact angle is greater than the water contact angle of the channel surface. Thus, the method allows for the differential coating of surfaces within the microfluidic device.

A surface may be primed by depositing a metal oxide onto it. Example metal oxides useful for priming surfaces include, but are not limited to, Al₂O₃, TiO₂, SiO₂, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be prepared on a surface by depositing trimethylaluminum (TMA) and water.

In some cases, the coating agent may create a surface that has a water contact angle greater than 90°, e.g., hydrophobic or fluorophillic, or may create a surface with a water contact angle of less than 90°, e.g., hydrophilic. For example, a fluorophillic surface may be created by flowing fluorosilane (e.g., H₃FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent. For example, when a liquid coating agent is used to coat a surface, the coating agent may be directly introduced to a channel, inlet, or reservoir by a feed channel in fluid communication with the channel, inlet, or reservoir. In order to keep the coating agent localized to the droplet source region, e.g., prevent ingress of the coating agent to another portion of the device, e.g., the channel, the portion of the device that is not to be coated can be substantially blocked by a substance that does not allow the coating agent to pass. For example, in order to prevent ingress of a liquid coating agent into the channel, the channel may be filled with a blocking liquid that is substantially immiscible with the coating agent. The blocking liquid may be actively transported through the portion of the device not to be coated, or the blocking liquid may be stationary. Alternatively, the channel may be filled with a pressurized gas such that the pressure prevents ingress of the coating agent into the channel. The coating agent may also be applied to the regions of interest external to the main device. For example, the device may incorporate an additional reservoir and at least one feed channel that connects to the region of interest such that no coating agent is passed through the device.

### EXAMPLES

It will be understood, that although channels, reservoirs, and inlets are labeled as “sample” and “reagent” herein, each channel, reservoir, and inlet may be for either a sample or a reagent being used.

### Example 1

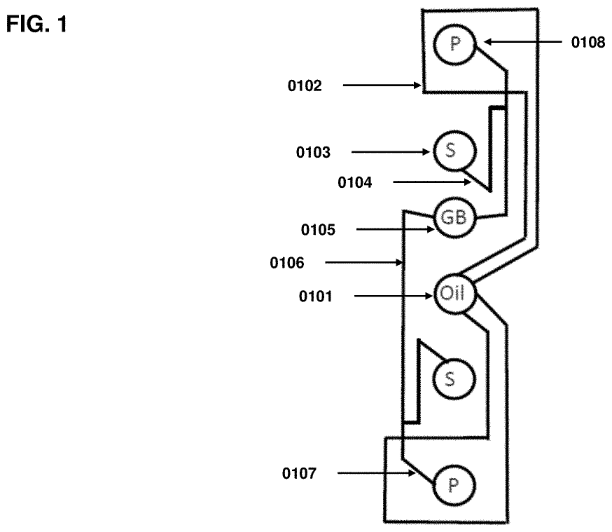

FIG. 1 is a schematic of a multiplex flow path. In the flow path, a single oil inlet 0101 is connected to four oil channels 0102. Two sample inlets 0103 are each connected to two sample channels 0104. A single reagent inlet 0105 is connected to two reagent channels 0106. Each sample channel intersects with a reagent channel and one of the two droplet channels 0107. After the sample and reagent channel intersection, each droplet channel intersects with two of the oil channels. The droplet channels each connect to one of two collection reservoirs 0108. As shown, the inlets and collection reservoirs may be in a substantially linear arrangement. Multiple multiplex flow paths may be included in a single device.

### Example 2

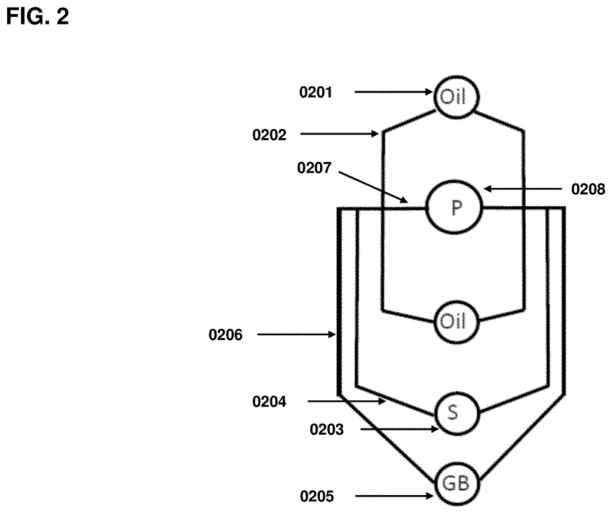

FIG. 2 is a schematic of a multiplex flow path. In the flow path, two oil inlets 0201 are connected to two oil channels 0202 each. A single sample inlet 0203 is connected to two sample channels 0204. A single reagent inlet 0205 is connected to two reagent channels 0206. Each sample channel intersects with a reagent channel and one of the droplet channels 0207. After the sample and reagent channel intersections, each droplet channel intersects with two of the oil channels. The droplet channels each connect to the single collection reservoir 0208. As shown, the inlets and collection reservoirs may be in a substantially linear arrangement. Multiple multiplex flow paths may be included in a single device.

### Example 3

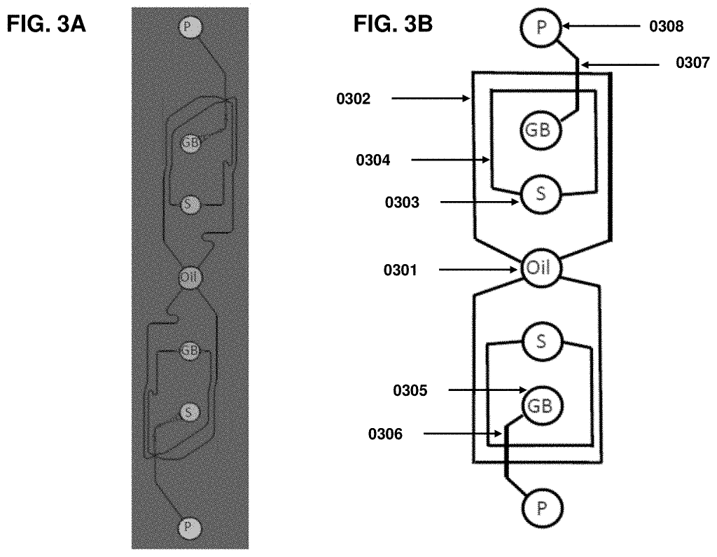

FIGS. 3A and 3B are a schematics of multiplex flow paths. In the flow path, a single oil inlet 0301 is connected to four oil channels 0302. Two sample inlets 0303 are connected to two sample channels 0304 each. Two reagent inlets 0305 are connected to one each of two reagent channels 0306. Each reagent channel intersects with two sample channels and one of two droplet channels 0307. After the sample and reagent channel intersections, each droplet channel intersects with two of the oil channels. The droplet channels each connect one of two collection reservoirs 0308. As shown, the inlets and collection reservoirs may be in a substantially linear arrangement. Multiple multiplex flow paths may be included in a single device.

### Example 4

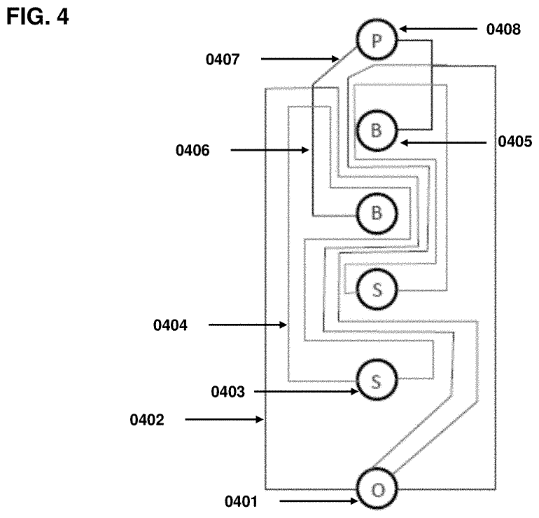

FIG. 4 is a schematic of a multiplex flow path. In the flow path, a single oil inlet 0401 is connected to four oil channels 0402. Two sample inlets 0403 are connected to two sample channels 0404 each. Two reagent inlets 0405 are each connected to one of two reagent channels 0406. Each reagent channel intersects with two sample channels and one of two droplet channels 0407. After the sample and reagent channel intersections, each droplet channel intersects with two of the oil channels. The droplet channels each connect to the one collection reservoir 0408. As shown, the inlets and collection reservoirs may be in a substantially linear arrangement. Multiple multiplex flow paths may be included in a single device.

### Example 5

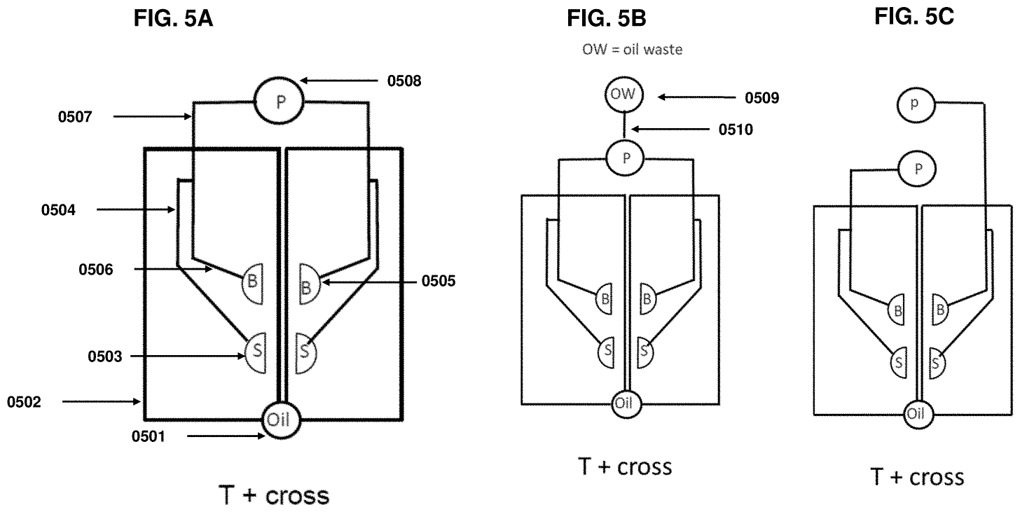

FIG. 5 is a schematic of a multiplex flow path. In the flow path, a single oil inlet 0501 is connected to four oil channels 0502. Two sample inlets 0503 are each connected to one of two sample channels 0504. Two reagent inlets 0505 are each connected to one of two reagent channels 0506. Each reagent channel intersects with one sample channel and one of two droplet channels 0507. After the sample and reagent channel intersections, each droplet channel intersects with two of the oil channels. The droplet channels each connect to the one collection reservoir 0508. Two of the four oil channels run between the two sample inlets and two reagent inlets. As shown, the inlets and collection reservoirs may be in a substantially linear arrangement. Multiple multiplex flow paths may be included in a single device. In FIG. 5B the multiplex flow path of FIG. 5A has an oil waste reservoir 0509 connected to the collection reservoir by an oil waste channel 0510, e.g., to collect excess oil. FIG. 5C shows a related embodiment with two collection reservoirs.

### Example 6

FIG. 6A is a schematic of a multiplex flow path. In the flow path, a single oil inlet 0601 is connected to four oil channels 0602. Two sample inlets 0603 are each connected to two of four sample channels 0604. Two reagent inlets 0605 are each connected to one of two reagent channels 0606. Each reagent channel intersects with two sample channels and one of two droplet channels 0607. After the sample and reagent channel intersections, each droplet channel intersects with two of the oil channels. The droplet channels each connect to the one collection reservoir 0608. Two of the oil channels and two of the sample channels run between the two reagent inlets and two of the oil channels run between the two sample inlets. As shown, the inlets and collection reservoirs may be in a substantially linear arrangement. Multiple multiplex flow paths may be included in a single device (such as shown in FIG. 6E for the related embodiment of FIG. 6D). In FIG. 6B the multiplex flow path of FIG. 6A has an oil waste reservoir 0609 connected to the collection reservoir by an oil waste channel 0610, e.g., to collect excess oil. FIG. 6C shows a related embodiment with two collection reservoirs. FIG. 6D shows another related embodiment with two collection reservoirs, both connected to an oil waste reservoir. FIG. 6E shows a device with ten of the flow paths of FIG. 6D. As shown in FIG. 6E multiple multiplexed flow paths may be connected by a shared trough, e.g., a trough connecting the oil inlets.

### Example 7

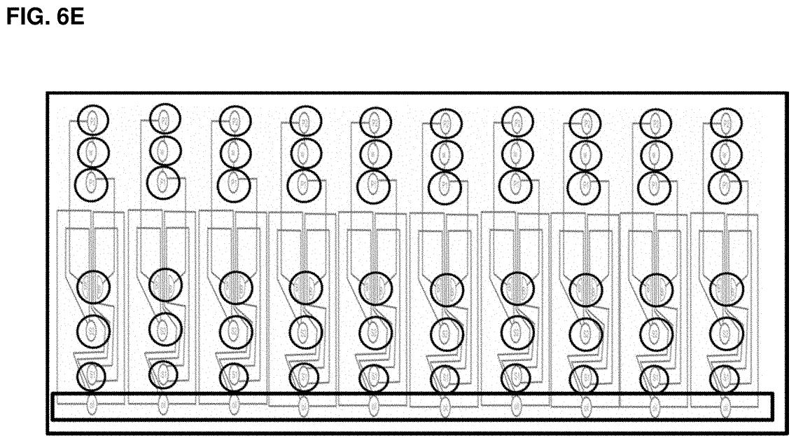

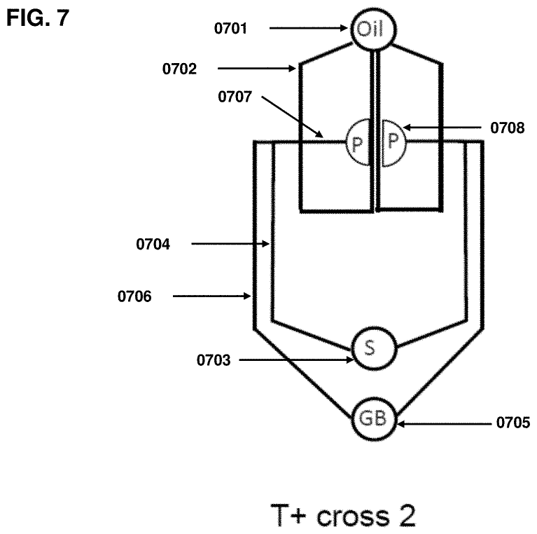

FIG. 7 is a schematic of a multiplex flow path. In the flow path, a single oil inlet 0701 is connected to four oil channels 0702. A single sample inlet 0703 is connected to two sample channels 0704. A single reagent inlet 0705 is connected to two reagent channels 0706. Each reagent channel intersects with one of the two sample channels and one of two droplet channels 0707. After the sample and reagent channel intersections, each droplet channel intersects with two of the oil channels. The droplet channels each connect to one of the two collection reservoirs 0708 . . . . Two of the four oil channels run between the two collection reservoirs.

As shown, the inlets and collection reservoirs may be in a substantially linear arrangement. Multiple multiplex flow paths may be included in a single device.

### Example 8

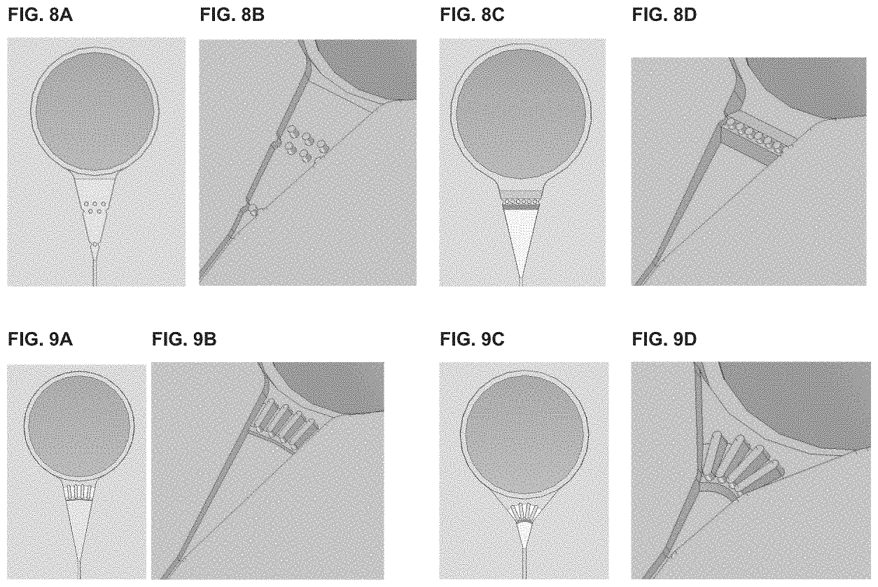

FIGS. 8A-8D and 9A-9D show exemplary funnel configurations that may be included in any of the devices described herein (e.g., in a sample or reagent channel).

FIG. 8A is a top view of an exemplary funnel that may be included, e.g., at the proximal end of a sample or reagent channel. The funnel includes two rows of pegs as hurdles closer to the funnel inlet and a single row of pegs (in this instance, a peg) closer to the funnel outlet. FIG. 8B is a perspective view of an exemplary funnel shown in FIG. 8A.

FIG. 9A is a top view of an exemplary funnel that may be included, e.g., at the proximal end of a sample or reagent channel. The funnel includes a barrier with one row of pegs disposed on top of the barrier as hurdle. FIG. 9B is a perspective view of an exemplary funnel shown in FIG. 9A.

FIG. 9C is a top view of an exemplary funnel that may be included, e.g., at the proximal end of a sample or reagent channel. The funnel includes a barrier with one row of pegs disposed on top of the barrier as hurdle. The pegs have a peg length that is greater than the peg width. FIG. 9D is a perspective view of an exemplary funnel shown in FIG. 9C.

### Example 9

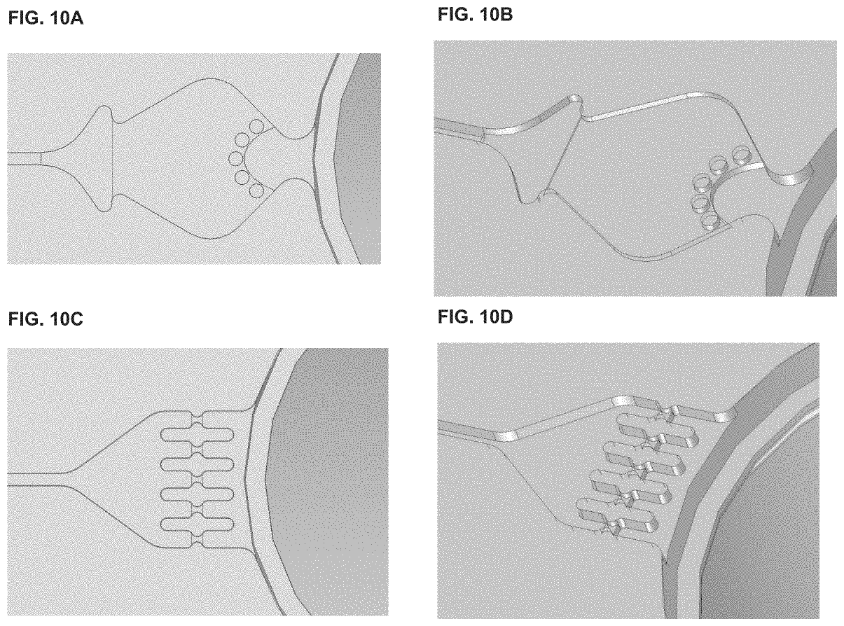

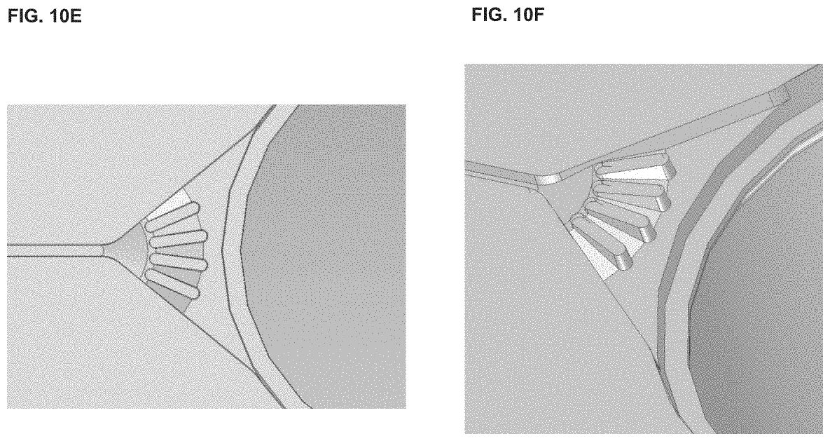

FIGS. 10A-10F show exemplary funnel configurations that may be included in any of the devices described herein (e.g., in a sample or reagent channel).

FIG. 10A is a top view of an exemplary funnel that may be included, e.g., at the proximal end of a sample or reagent channel. The funnel includes a barrier with one row of pegs disposed along a curve on top of the barrier as hurdle. FIG. 10B is a perspective view of an exemplary funnel shown in FIG. 10B.

FIG. 10C is a top view of an exemplary funnel that may be included, e.g., at the proximal end of a sample or reagent channel. The funnel includes a barrier with one row of pegs disposed on top of the barrier as hurdle. The pegs have a peg length that is greater than the peg width. FIG. 10D is a perspective view of an exemplary funnel shown in FIG. 10C.

FIG. 10E is a top view of an exemplary funnel that may be included, e.g., at the proximal end of a sample or reagent channel. The funnel includes a barrier with one row of pegs disposed along a curve. The pegs have a peg length that is greater than the peg width. The funnel also includes a ramp. FIG. 10F is a perspective view of an exemplary funnel shown in FIG. 10E.

### Example 10

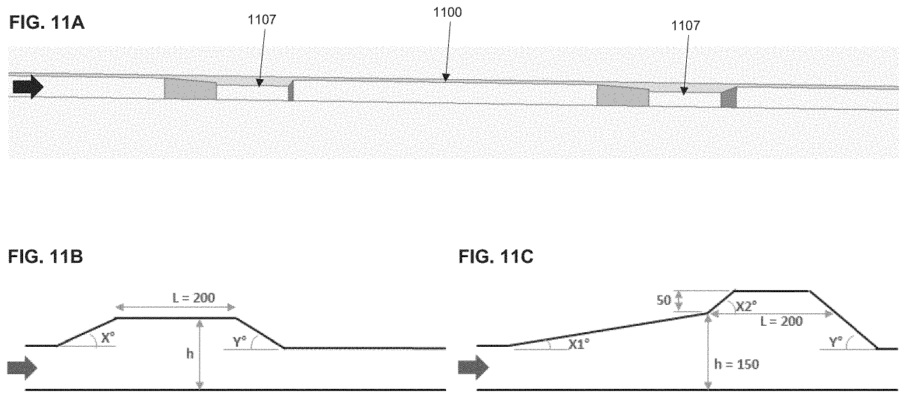

FIGS. 11A-11C show exemplary traps arranged in a channel. These traps can be included in any of the devices described herein (e.g., in a sample reagent, or droplet channel). FIG. 11A is a top view of an exemplary series of traps. In this figure, channel 1100 includes two traps 1107. The solid-fill arrow indicates the liquid flow direction through the channel including a series of traps. FIG. 11B is a side view cross section of a channel including a trap. The trap has a length (L) and depth (h). In operation, air bubbles that might be carried with a liquid can be lifted by the air buoyancy and thus are removed from the liquid flow. FIG. 11C is a side view cross section of a channel including a trap. The trap has a length (L) and depth (h+50). In operation, air bubbles that might be carried with a liquid can be lifted by the air buoyancy and thus are removed from the liquid flow.

### Example 11

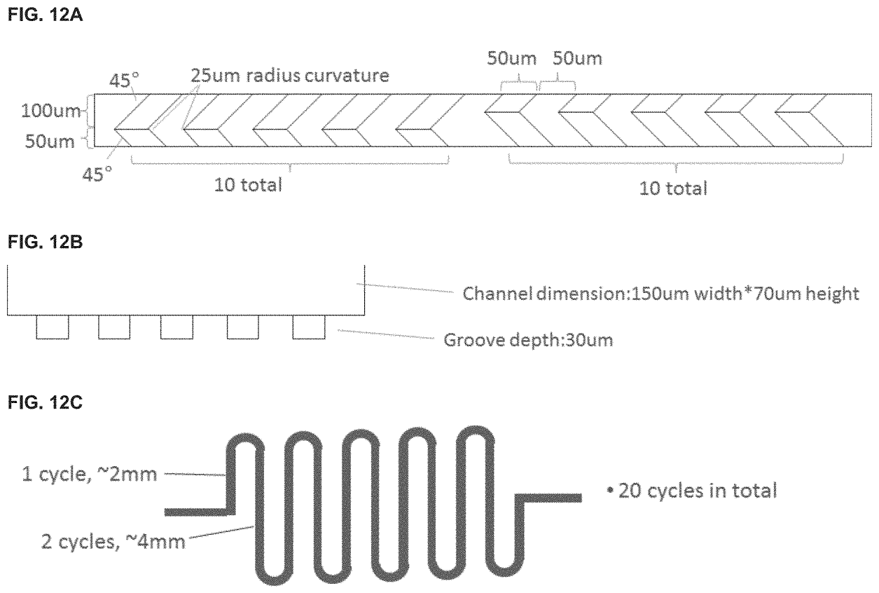

FIGS. 12A-12C show an exemplary herringbone mixer and its arrangement in a channel. These mixers can be included in any of the devices described herein (e.g., in a sample reagent, or droplet, preferably, after an intersection in which two or more liquids from different liquid sources mix). FIG. 12A is a top view of an exemplary herringbone mixer. This herringbone mixer may be used to provide a single mix cycle in a channel. The herringbone mixer includes and grooves extending transversely across the channel. In this drawing, um stands for microns. FIG. 12B is a side view cross section of an exemplary herringbone mixer portion shown in FIG. 12A. In this drawing, um stands for microns. FIG. 12C is a top view of an exemplary herringbone mixer including twenty mix cycles assembled from herringbone mixers shown in FIG. 12A.

### Example 12

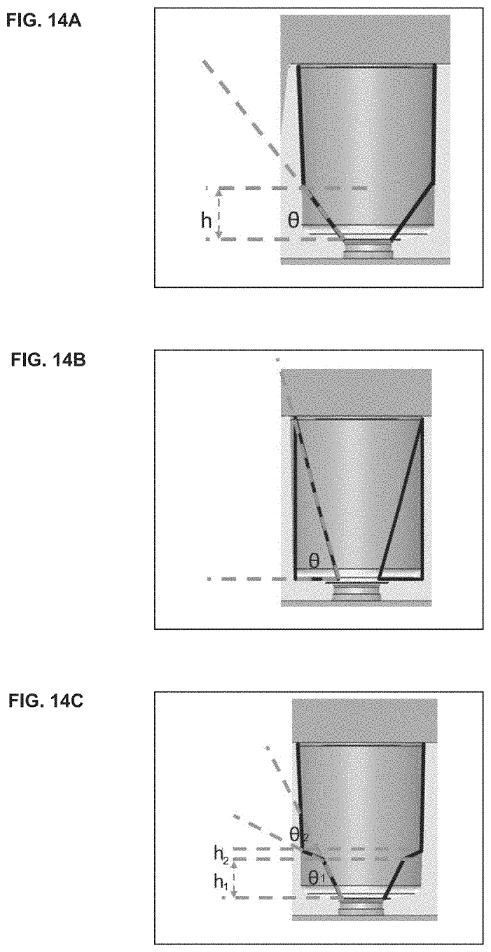

FIG. 13A shows a collection reservoir with a vertical side wall. FIG. 13B and FIGS. 14A-14C show exemplary collection reservoirs including a canted side wall (e.g., side walls canted at angles between 89.5° and 4°, e.g., between 85° and 5°, e.g., 5°≤θ≤85°). The canted side walls may increase the collection efficiency of droplets by a collection device (e.g., a pipette tip) by up to about 20%.

### Example 13

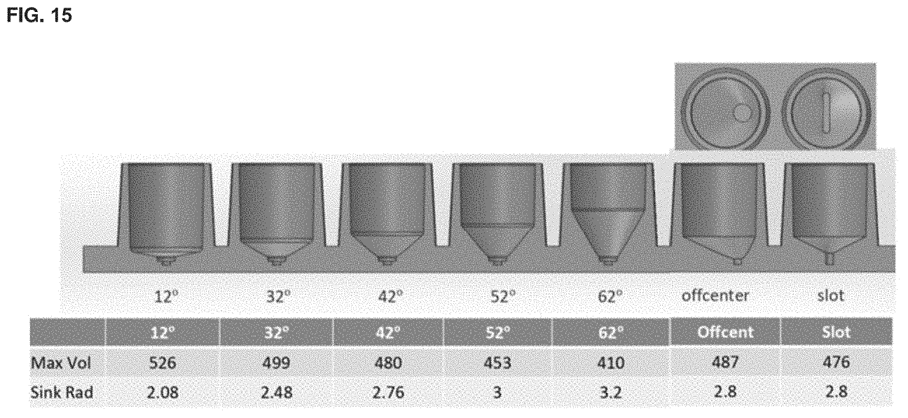

FIG. 15 is a depiction of side view cross sections of exemplary reservoirs including canted sidewalls, an oblique circular cone shape, and a circular cone that tapers to a slot. The canted side walls, and/or oblique circular cone shape, and/or circular cone that tapers to a slot shapes may increase the collection efficiency of droplets by a collection device (e.g., a pipette tip).

### Example 14

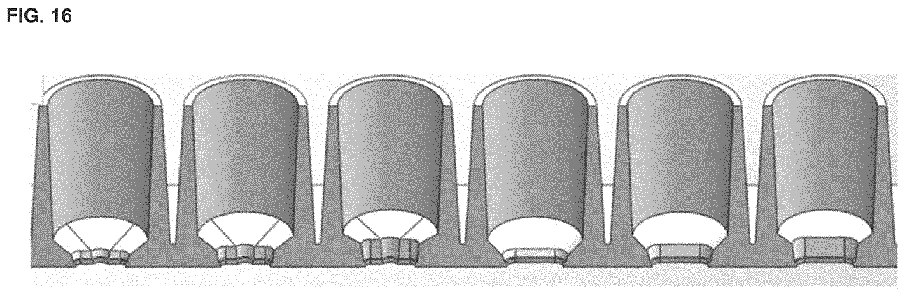

FIG. 16 is a depiction of side view cross sections of exemplary reservoir including canted sidewalls and slots, and slots with protrusions. The canted side walls, and/or slot shapes with or without protrusions may increase the collection efficiency of droplets by a collection device (e.g., a pipette tip), while also reducing droplet coalescence during extraction. These designs may shape the bottom of the reservoir to guide a pipette tip to the bottom, prevent sealing the tip against the bottom-most surface, and/or introduce a gap between the tip and the bottom-most surface that does not induce coalescence of droplets through high shear during retrieval of the emulsion. These designs may also allow high efficiency collection of droplets without tilting the device.

### Example 15

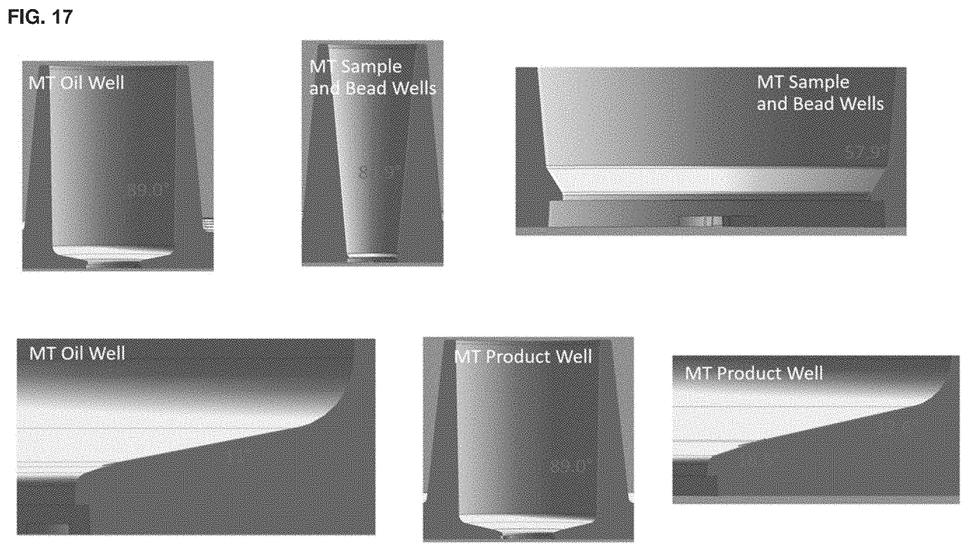

FIG. 17 is a depiction of side view cross sections of exemplary reservoirs or inlets. The canted side walls may increase the collection efficiency of droplets, or introduction efficiency of samples or reagents, e.g., by up to about 20%.

### Example 16

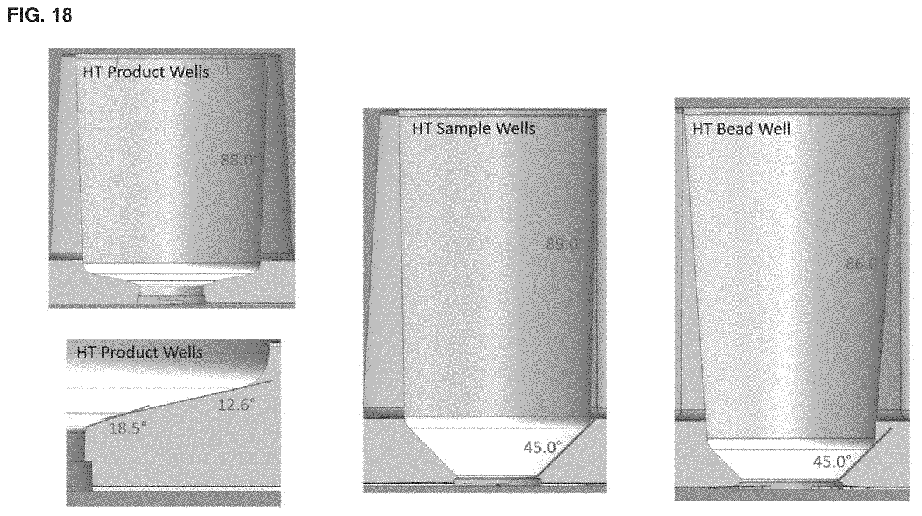

FIG. 18 is a depiction of side view cross sections of exemplary reservoirs or inlets. The canted side walls may increase the collection efficiency of droplets, or introduction efficiency of samples or reagents, e.g., by up to about 20%.

### Other Embodiments

Various modifications and variations of the described invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

What is claimed is:

1. A device for producing droplets comprising a flow path comprising:
a) one or more sample inlets;
b) one or more reagent inlets;
c) one or more oil inlets;
d) one or more collection reservoirs;
e) a first and a second sample channel, each in fluid communication with the one or more sample inlets;
f) a first and a second reagent channel, each in fluid communication with the one or more reagent inlets;
g) a first, second, third, and fourth oil channel in fluid communication with the one or more oil inlets;
h) a first intersection at which the first reagent channel and the first sample channel intersect;
i) a second intersection at which the second reagent channel and the second sample channel intersect;
j) a first and a second droplet channel, wherein the first droplet channel is in fluid communication with the first intersection and the one or more collection reservoirs and the second droplet channel is in fluid communication with the second intersection and the one or more collection reservoirs;
k) a third intersection at which the first and second oil channels and the first droplet channel intersect, wherein the third intersection is fluidically disposed between the first intersection and the one or more collection reservoirs; and
l) a fourth intersection at which the third and fourth oil channels and the second droplet channel intersect, wherein the fourth intersection is fluidically disposed between the second intersection and the one or more collection reservoirs.

2. The device of claim 1, wherein the one or more sample inlets comprise a first and a second sample inlet, the one or more reagent inlets comprise a first reagent inlet, the one or more oil inlets comprise a first oil inlet, and the one or more collection reservoirs comprise a first and a second collection reservoir; and wherein the first sample channel is in fluid communication with the first sample inlet, the second sample channel is in fluid communication with the second sample inlet, the first droplet channel is in fluid communication with the first collection reservoir, the second droplet channel is in fluid communication with the second collection reservoir.

3. The device of claim 1, wherein the one or more sample inlets comprise a first sample inlet, the one or more reagent inlets comprise a first reagent inlet, the one or more oil inlets comprise a first and a second oil inlet, and the one or more collection reservoirs comprise a first collection reservoir; and wherein the first and third oil channels are in fluid communication with the first oil inlet and the second and fourth oil channels are in fluid communication with the second oil inlet.

4. The device of claim 1, further comprising a third and a fourth sample channel each in fluid communication with the one or more sample inlets, wherein the third sample channel intersects the first reagent channel at the first intersection and the fourth sample channel intersects the second reagent channel at the second intersection.

5. The device of claim 4, wherein the one or more sample inlets comprise a first and a second sample inlet, the one or more reagent inlets comprise a first and a second reagent inlet, the one or more oil inlets comprise a first oil inlet, and the one or more collection reservoirs comprise a first and a second collection reservoir; and wherein the first and third sample channels are in fluid communication with the first sample inlet, the second and fourth sample channels are in fluid communication with the second sample inlet, the first reagent channel is in fluid communication with the first reagent inlet, the second reagent channel is in fluid communication with the second reagent inlet, the first droplet channel is in fluid communication with the first collection reservoir, and the second droplet channel is in fluid communication with the second collection reservoir.

6. The device of claim 4, wherein the one or more sample inlets comprise a first and a second sample inlet, the one or more reagent inlets comprise a first and a second reagent inlet, the one or more oil inlets comprise a first oil inlet, the one or more collection reservoirs comprise a first collection reservoir; and wherein the first and third sample channels are in fluid communication with the first sample inlet, the second and fourth sample channels are in fluid communication with the second sample inlet, the first reagent channel is in fluid communication with the first reagent inlet, and the second reagent channel is in fluid communication with the second reagent inlet.

7. The device of claim 1, wherein the one or more reagent inlets comprise a first and a second reagent inlet, the one or more sample inlets comprise a first and a second sample inlet, the first reagent channel is in fluid communication with the first reagent inlet, the first sample channel is in fluid communication with the first sample inlet, the second reagent channel is in fluid communication with the second reagent inlet, the second sample channel is in fluid communication with the second sample inlet, and wherein one or more of the first through fourth oil channels is disposed between the first and second reagent inlets and/or between the first and second sample inlets.

8. The device of claim 7, wherein the one or more collection reservoirs comprise first and second collection reservoirs, the first droplet channel is in fluid communication with the first collection reservoir and the second droplet channel is in fluid communication with the second collection reservoir.

9. The device of claim 7, further comprising a third sample channel in fluid communication with the first sample inlet and a fourth sample channel in fluid communication with the second sample inlet; wherein the third sample channel intersects the first reagent channel at the first intersection and the fourth sample channel intersects the second reagent channel at the second intersection; and wherein the third and fourth sample channels are disposed between the first and second reagent inlets.

10. The device of claim 6, further comprising an oil waste reservoir and one or more oil waste channels, wherein each oil waste channel is in fluid communication with the oil waste reservoir and in fluid communication with the one or more collection reservoirs.

11. The device of claim 1, wherein the one or more collection reservoirs comprise first and second collection reservoirs, the first droplet channel is in fluid communication with the first collection reservoir and the second droplet channel is in fluid communication with the second collection reservoir, and wherein one or more of the first through fourth oil channels are disposed between the first and second collection reservoirs.

12. The device of claim 1, wherein at least one of the one or more sample channels and/or the one or more reagent channels comprise one or more rectifiers.

13. (canceled)

14. A method of producing droplets comprising:
a) providing a device of claim 1;
b) flowing one or more first fluids from the one or more sample inlets through the first and second sample channels, one or more second fluids from the one or more reagent inlets through the first and second reagent channels, and one or more third fluids through the first, second, third, and fourth oil channels; wherein one of the one or more first fluids and one of the one or more second fluids combine independently at the first and second intersections and produce droplets in the third fluid at the third and fourth intersections; and
c) collecting the droplets in the one or more collection reservoirs.

15.-26. (canceled)

27. The method of claim 14, wherein the one or more first fluids comprise a plurality of biological particles and wherein at least a portion of the droplets collected in step (c) comprises at least one of the plurality of biological particles.

28. The method of claim 14, wherein the one or more second fluids comprise a plurality of beads and wherein at least a portion of the droplets collected in step (c) comprises at least one of the plurality of beads.

29. A system for producing droplets comprising:
a) a device according to claim 1;
b) one or more first fluids disposed in the first and second sample channels;
c) one or more second fluids disposed in the first and second reagent channels;
d) one or more third fluids disposed in the first, second third, and fourth oil channels; and
e) optionally particles in the one or more sample inlets and/or the one or more reagent inlets and droplets in the one or more collection reservoirs;
wherein the one or more first fluids and one or more second fluids are immiscible in the one or more third fluids; and
wherein the system is configured to produce droplets of the one or more first fluids and the one or more second fluids in the one or more third fluids.

30.-34. (canceled)

35. The system of claim 29, wherein the one or more reagent inlets of the device comprise a first and a second reagent inlet, the one or more sample inlets comprise a first and a second sample inlet, the first reagent channel is in fluid communication with the first reagent inlet, the first sample channel is in fluid communication with the first sample inlet, the second reagent channel is in fluid communication with the second reagent inlet, the second sample channel is in fluid communication with the second sample inlet; and wherein one or more of the first through fourth oil channels is disposed between the first and second reagent inlets and/or between the first and second sample inlets.

36.-41. (canceled)

42. The system of claim 29, wherein the particles in the one or more sample inlets comprise biological particles.

43. The system of claim 29, wherein the particles in the one or more reagent inlets comprise gel beads.

44. The system of claim 29, wherein the device comprises a plurality of flow paths.
